(19) United States
(12) Patent Application Publication
(10) Pub. No.: US 2022/0073758 A1
(43) Pub. Date: Mar. 10, 2022

(54) PROCESS FOR PREPARING A SURFACE WITH BACTERIOSTATIC ACTIVITY AND SURFACE THUS PREPARED

(71) Applicants: COMMISSARIAT Å L'ÉNERGIE ATOMIQUE ET AUX ÉNERGIES ALTERNATIVES, Paris (FR); CENTRE NATIONAL DE LA RECHECHE SCIENTIFIQUE, PARIS Cedex 16 (FR); INSTITUTE NATIONAL DE RECHERCHE POUR L'AGRICULTURE, L'ALIMENTION ET L'ENIRONNEMENT, PARIS CEDEX 7 (FR)

(72) Inventors: Géraldine Carrot, GIF Cedex (FR); Marie-Noëlle Bellon-Fontaine, Paris (FR); Sarah Bernardi, Saint-Dolay (FR)

(21) Appl. No.: 17/299,198

(22) PCT Filed: Dec. 4, 2019
(86) PCT No.: PCT/FR2019/052921

§ 371 Date: Jun. 2, 2021

(30) Foreign Application Priority Data
Dec. 4, 2018 (FR) 1872310

(51) Int. Cl. C09D 5/14; C09D 165/00; A01N 43/38; A01P 1/00; A01N 25/08; B65D 81/28; B65D 65/42

(52) U.S. Cl. CPC C09D 5/14; C09D 165/00; A01N 43/38; B65D 65/42; A01N 25/08; B65D 81/28; A01P 1/00

(57) ABSTRACT

A process for imparting bacteriostatic or bactericidal properties to the surface of an object, which consists in (a) providing an object of which the surface bears groups comprising at least one oxygen atom; (b) applying, to the surface provided in step (a), a coating based on polymers of polydopamine or a derivative thereof carrying at least one function —Y, where Y is a halogen atom or a function —N(R11)(R12) in which R11 and R12 are identical or different and are a hydrogen atom, an optionally substituted alkyl group or an optionally substituted aryl group; and (c) contacting the coated surface obtained after step (b) with a solution containing at least one dihalogen and at least one diamine at a temperature greater than ambient temperature, whereby a polyionene polymer-based coating is grafted covalently to said coated surface obtained after step (b).

### TECHNICAL FIELD

The present invention belongs to the technical field of antibacterial surfaces and more particularly surfaces to which polymers with bacteriostatic or bactericidal activity of the polyionene type adhere and are covalently grafted.

More particularly, the present invention relates to a method for imparting bacteriostatic or bactericidal properties to the surface of an object consisting in depositing and/or grafting, covalently and sequentially, a coating of the polydopamine type, functionalised so as to participate in a polyaddition and a coating of the polyionene type. The present invention also relates to the surface having bacteriostatic and bactericidal properties thus prepared and uses thereof.

### PRIOR ART

For both economic and environmental preoccupations, there has been an increasing demand, during the past years, for antibacterial surfaces or coatings that provide a lasting decontamination action in the field of packaging of food products such as fresh food products, the environment or the health environment.

Former generations of antimicrobial coatings with chemical elution have only a short-term antimicrobial effect and cause toxicity and/or microbial resistance. The widespread use of solutions is also expensive and has a significant negative impact on the environment (effluents). An active coating by contact containing immobilised antimicrobial agents is less susceptible to cause the development of a resistance to bacteria. Indeed, this class of coating disrupts the membranes of the bacteria without targeting their metabolic activity, which is associated with the appearance of a resistance. Antimicrobial polymers, in particular cationic, have been applied as pro-adhesive coatings and have been reported to effectively disrupt the cytoplasmic membrane of undesirable bacteria (spoilage and pathogenic flora) [1]. However, many questions remain as to the influence of the structure and the architecture of the polymer film on its antibacterial properties.

With regards to nosocomial infections, daily problems, packaging of fresh products and purification of water, there is a need for stable, robust and effective antibacterial coatings. Inorganic nanoparticles, and in particular silver nanoparticles, are often chosen for reinforcing the antibacterial effect of polymer films in terms of activity and stability. The main problem is the release of these nanoparticles, in particular toxic silver nanoparticles, or of the corresponding ions in the surrounding environment. It should be noted that, in general, the use of silver nanoparticles has been limited because of the risk of toxicity. Other examples of inorganic composites comprise the use of less toxic nanoparticles, such as ZnO, copper or TiO₂. However, the marketing of plastic films containing inorganic nanoparticles for applications in the food field for example has encountered much reticence from producers.

The other way also explored in particular in the field of packaging consists in the adsorption or grafting of small molecules such as triclosan, nisin or essential oils such as thymol or carvacrol. The problem lies in the release of these molecules from the packaging, because of their simple physical adsorption on the film and/or the low thermal stability of the molecules at the high temperatures of the packaging process. This is a serious problem relating to potentially toxic molecules such as triclosan known as an endocrine disruptor, but also in the case of “safer” molecules such as essential oils. Indeed, the diffusion thereof in food or the environment (water) is liable to cause a modification of the taste. An alternative way is to immobilise the antimicrobial agent on clay of the montmorillonite type, in order to control the diffusion thereof and to increase the thermal stability.

The prior art also knows coatings on which antimicrobial agents are immobilised. Cationic antimicrobial peptides (or AMPs, standing for “AntiMicrobial Peptides”) have proved to be particularly effective because of the particular antimicrobial activity thereof based on non-specific electrostatic and hydrophobic interactions [2].

As already mentioned, antimicrobial polymers are particularly interesting since they generally also have a long-term activity with in addition high chemical stability (reduction of residual toxicity and microbial resistance). Among these, polycations based on quaternary ammonium salts and with a modulatable amphiphilic character have been described as capable of effectively disrupting the external cytoplasmic membrane of cells causing lysis and therefore cell death. It has been shown that one of the key parameters for an effective antibacterial effect of the polymer is the amphiphilic character thereof, namely the hydrophobic/charge ratio. When these polymers are used as active coatings by contact (bacteriostatic), it has been clearly shown that (i) the presence of sufficiently long hydrophobic chains is necessary for penetrating and bursting the bacterial membrane, and (ii) high levels of positive charges are necessary for conferring antimicrobial properties, independently of the length of the hydrophobic chains [1].

In this context, polyionenes or ionenes containing quaternary ammoniums, in the principal chain of the polymer or skeleton, separated by hydrophobic fragments, are particularly interesting candidates [3-7]. Indeed, Tiller et al. have demonstrated that polyionenes have particularly effective antimicrobial properties, mainly because of the presence of variable-length alkyl groups [4]. It has also been shown that these polymers have low cytotoxicity [5] and the Argawal group also introduced ethoxyethyl and aliphatic segments inside the ionene structure to evaluate the influence of these segments with regard to biocidal activity and to reinforce the biocompatibility of these polymers [6]. More recently, a complete study on the activity of ionenes was carried out by the Hedrick and Yang groups on clinically isolated multiresistant microorganisms (MDR) [7]. They particularly revealed the ability of ionenes to attenuate the resistance of bacteria.

The patent U.S. Pat. No. 4,980,067 proposes cladding or grafting microporous membranes with polyionenes, in order to eliminate contaminants of the microorganism type possibly present in biological liquids [8]. More particularly, this patent describes incorporating polyionenes in microporous membranes consisting of nylon and potentially positively charged. This incorporation is done via a method using a binding agent of the epoxy type present in the form either of an additive or of reactive functions in the polymer. The latter strategy is limiting as to the selection of the polyionene to be incorporated. Moreover, there is no characterisation of grafting reactions used making it possible to state that the polyionene is not simply adsorbed or even salted out in solution. Indeed, the only tests that are performed in the experimental part of [8] are tests on the inhibition of the growth of the bacteria and the method used, namely measuring the optical density, is particularly adapted to solutions rather than to surfaces.

The inventors set themselves the aim of proposing a simple robust method that is capable of industrial application, making it possible to obtain a novel active coating able to control, to limit or to inhibit the bacterial growth of undesirable flora (spoilage and pathogenic), for applications both in the food field and in the medical, military or environmental domain.

The inventors also set themselves the aim of proposing a simple robust method that is capable of industrial application, making it possible to obtain a novel active coating not having the drawbacks of the coatings of the prior art, in particular in terms of release of compounds.

### DESCRIPTION OF THE INVENTION

The present invention makes it possible to achieve the aim that the inventors set themselves and therefore relates to a method for preparing a pro-adhesive coating with bacteriostatic or bactericidal properties aimed at obtaining a bacteria trap.

The coating prepared by the method according to the invention is based on the use of a bacteriostatic or bactericidal polymer film based on polyionenes wherein the majority of the undesirable bacteria are trapped to limit the growth thereof so as to prevent multiplication thereof on the product or the environment. In addition, to avoid any phenomenon of release, the method according to the invention involves a succession of coatings, adherent or grafted, robustly and/or covalently, from the initial substrate to the bacteriostatic or bactericidal polymers. For this purpose, the method according to the invention implements a plurality of adhesion, grafting and/or polymerisation steps of the “grafting-from” type that are more adapted to an effective incorporation of polymers on surfaces, in particular for reasons of steric hindrance. This aspect is all the more important since the bacteriostatic or bactericidal polymers involved in the present invention are charged polymers.

Moreover, the inventors have shown that the use of active polymers leads to several advantages: i) a larger quantity of biocidal groups, ii) a greater mobility, which is an important parameter for interactions with the bacterial membrane, iii) better stability with respect to the temperatures, for example, used in the processes of preparing packaging films. The more particular use of polymers of the polyionene type offers not only the advantage of having a bacteriostatic or bactericidal property that is both pro-adhesive (the bacteria are trapped) and modulatable with regard to the bactericidal power. Indeed, according to the monomers (dihalogens and diamines) used for preparing these polymers, it is possible to inhibit, in whole or in part, the strains present.

In the field of food packaging, the coating according to the invention, which is both pro-adhesive and bacteriostatic/bactericidal, makes it possible to trap undesirable flora (spoilage and pathogenic) irreversibly and has a particularly advantageous impact, both economic and environmental. Indeed, it is particularly useful for better preservation of fresh products, reduction in the use-by date (UBD) and reduction in food waste in the packaging field.

Beyond the application in the food field, the present invention can also usefully apply in the medical, health, military or environmental field in the broad sense, for the purpose of manufacturing decontamination or purification objects such as rod, probe, paper, textile and membrane and/or “container” surfaces such as a tray, case and packaging film that can advantageously serve as “bacteria traps”. The low cytotoxicity of polyionenes and the ability thereof to limit bacteria resistance are assets for this type of application.

More particularly, the present invention relates to a method for imparting bacteriostatic or bactericidal properties to the surface of an object consisting in:

a) providing an object the surface of which bears groups comprising at least one oxygen atom;

b) depositing, on the surface provided in step (a), a coating based on polymers of polydopamine or one of the derivatives thereof, carrying at least one —Y function with Y representing a halogen atom or an —N(R11)(R12) function with R11 and R12, identical or different, representing a hydrogen atom, an alkyl group, optionally substituted, or an aryl group, optionally substituted; and

c) bringing the coated surface obtained following said step (b) in contact with a solution containing at least one dihalogen and at least one diamine at a temperature higher than ambient temperature, whereby a coating based on polyionene polymers is grafted, covalently, on said coated surface obtained following said step (b).

As previously mentioned, the present invention applies to any object that can serve not only in the packaging and preservation of products but also as a decontamination and/or purification device in the health field or the environment field. This object can therefore be selected from the group consisting of a film such as for example a packaging film, a box, a tray, a case, a lid, a sachet, dialysis equipment, a rod, a probe, paper, a textile, a membrane and a filter.

The surface of the object may be an inorganic or organic surface. The material of this surface may be selected from the group consisting of glass; a polymer material or resin such as polyethylene (PE), polycarbonate (PC), polystyrene (PS), polypropylene (PP), polyethylene terephthalate (PET), polymethyl methacrylate (PMMA), an epoxy resin, polyurethane, etc.; a metal material such as stainless steel, tin or aluminium; silicon; silica; clays; ceramics; natural fibres and synthetic fibres.

The first step of the method according to the present invention, i.e. step (a), consists in providing an object the surface of which bears a plurality of groups, identical or different, comprising at least one oxygen atom.

Advantageously, in the context of the present invention, a group comprising at least one oxygen atom is selected from the group consisting of a carboxylic group (—C(═O)OH), a hydroxyl group (—OH), an alkoxyl group (—OX with X representing an alkyl group, an acyl group or an aryl group), a carbonyl group (—C(═O)—), a percarbonic group (—C(═O)—O—OH) and an amide group (—C(═O)NH₂). Typically, in the context of the present invention, a group comprising at least one oxygen atom is a hydroxyl group (—OH).

In a particular embodiment, the surface of the object on which the method of the present invention is applied, bears, through its chemical nature, such groups.

In a variant, when the surface of the object on which the method of the invention is applied does not bear such groups or when it is wished to increase the number thereof, the surface is subjected to an oxidising treatment. In other words, the step (a) of the method according to the invention consists in subjecting the surface of the object to an oxidising treatment. The latter aims to oxidise the surface of the object used by fixing and/or by introducing on the latter oxygen-rich groups, i.e. groups comprising at least one oxygen atom as previously defined.

Such an oxidising treatment is based on two major types of surface modification based on:
physical treatments such as a plasma treatment in particular oxygen, a UV treatment, a treatment with X or gamma rays, a treatment by irradiation with electrons and heavy ions;
chemical treatments such as treatment with alcoholic potash, a treatment with a mixture of sulfuric acid (H₂SO₄) and hydrogen peroxide (H₂O₂), also known by the term “piranha mixture”, a treatment with a strong acid (HCl, H₂SO₄, HNO₃, HClO₄), a treatment with soda, a treatment by a strong oxidising agent (KMnO₄, K₂Cr₂0₂, KClO₃ or CrO₃ in hydrochloric acid, sulfuric acid or nitric acid), a treatment with ozone and a heat treatment under oxygenated atmosphere (O₂, H₂O, etc.).

A person skilled in the art will be able to determine the treatment, physical and/or chemical, best adapted according to the chemical nature of the surface of the object.

The essential elements used during step (b) of the method according to the invention are, on the one hand, polymers of polydopamine or of a derivative of polydopamine deposited on the surface of the object, and, on the other, functions of formula —Y with Y as previously defined carried, directly or indirectly, by the polymers of polydopamine or of a derivative of polydopamine.

Hereinafter and hereinabove, the expressions “function of formula —Y” and “function —Y” are equivalent and can be used interchangeably.

By definition, a function of formula —Y is either a halogen atom, or a function of the type —N(R11)(R12) with R11 and R12, identical or different, representing a hydrogen atom, an alkyl group, optionally substituted, as previously defined or an aryl group, optionally substituted.

“Aryl group” means, in the context of the present invention, any group comprising an aromatic ring or a plurality of aromatic rings, identical or different, bonded or connected by a simple bond or by a hydrocarbon chain, an aromatic ring having 3 to 20 carbon atoms, notably 3 to 14 carbon atoms and in particular 3 to 8 carbon atoms and which may optionally comprise a heteroatom. By way of aryl group that can be used in the invention, mention can be made of a phenyl group.

“Heteroatom” means, in the context of the present invention, an atom selected from the group consisting of a nitrogen, an oxygen, a phosphorus, a sulfur, a silicon, a fluorine, a chlorine and a bromine.

“Substituted aryl group” means, in the context of the present invention, an aryl group as previously defined substituted by a group or several groups, identical or different, selected from the group consisting of a halogen; an amine; a diamine; a carboxyl; a carboxylate; an aldehyde; an ester; an ether; a ketone; a hydroxyl; an optionally substituted alkyl; an amide; a sulphonyl; a sulfoxide; a sulfonic acid; a sulfonate; a nitrile; a nitro; an acyl; a vinyl; an epoxy; a phosphonate; an isocyanate; a thiol; a glycidoxy; and an acryloxy.

“Halogen” means, in the context of the present invention, an atom selected from the group consisting of an iodine, a fluorine, a chlorine and a bromine.

“Alkyl group” means an alkyl group, linear, branched or cyclic, comprising from 1 to 20 carbon atoms, notably from 1 to 15 carbon atoms and in particular from 1 to 10 carbon atoms, said alkyl group optionally being able to comprise at least one heteroatom and/or at least one double or triple carbon-carbon bond.

“Substituted alkyl group” means, in the context of the present invention, an alkyl group as previously defined substituted by a group or several groups, identical or different, selected from the group consisting of a halogen; an amine; a diamine; a carboxyl; a carboxylate; an aldehyde; an ester; an ether; a ketone; a hydroxyl; an optionally substituted alkyl; an amide; a sulphonyl; a sulfoxide; a sulfonic acid; a sulfonate; a nitrile; a nitro; an acyl; a vinyl; an epoxy; a phosphonate; an isocyanate; a thiol; a glycidoxy; and an acryloxy.

When the function of formula —Y represents a halogen atom, the latter advantageously represents a bromine atom, a chlorine atom or an iodine atom. In particular, Y represents a bromine atom.

When the function of formula —Y is a function of the type —N(R11)(R12), the radicals R11 and R12 are advantageously identical. In particular, the radicals R11 and R12 are identical and represent a methyl or ethyl group.

As a reminder, dopamine is also known by the name (3,4-dihydroxyphenyl)ethylamine. Dopamine and the polymer resulting from the polymerisation of dopamine, i.e. polydopamine, have the following chemical structures:

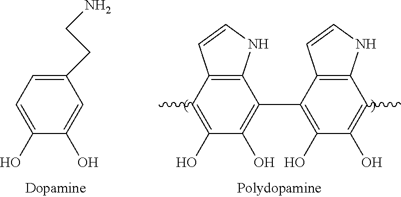

From a reaction point of view and as described in the literature, the catechol groups of the dopamine polymerise and the aminated arms close on the catechol ring in order to give polydopamine. More particularly, oxidation of dopamine produces 5,6-dihydroxyindole (DHI) and indole-5,6-quinone (01). These precursors bind together covalently in insoluble oligomers, which aggregate because of the π-π stack, charge transfers and hydrogen bonds [9]. The polydopamine films therefore form from precursor solutions at the interface of numerous materials, including noble metals, oxides, semiconductors, ceramics and polymers [10]. Studies have also shown that catechol groups are mainly responsible for the robust adhesion of the polydopamine films [11]. The bonds described by Kohri and Kawamura, 2016 [12] as involved in this adhesion are coordination bonds, hydrogen bonds and/or hydrophobic bonds.

“Polymer derivative of polydopamine” means a polymer obtained by polymerisation of a compound of formula (I) as defined in the international application WO 2008/049108 [13]. More precisely, formula (I) is as follows:

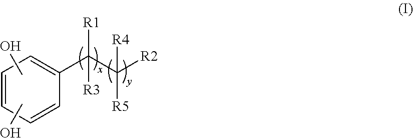

wherein:
the R1, R2, R3, R4 and R5 groups are independently selected from the group consisting of a hydrogen, a hydroxyl, a halogen, a thiol, an aldehyde, a carboxylic acid, a carboxylic ester, a carboxamide, a primary amine, a secondary amine, a nitrile, an imidazole, an azide or a polyhexamethylene dithiocarbamate;

provided that at least one group from the R1, R2, R3, R4 and R5 groups is not a hydrogen;
x is equal to 0 or represents an integer number between 1 and 10, the bounds 1 and 10 being inclusive; and
y is equal to 0 or represents an integer number between 1 and 10, the bounds 1 and 10 being inclusive;

provided that x or y is at least equal to 1.

The present invention also applies to all the variants and all the preferred embodiments of the compounds of formula (I) as described in the international application WO 2008/049108 [13].

In particular, the compound the polymerisation of which results in a polydopamine derivative complies with the following formula (II):

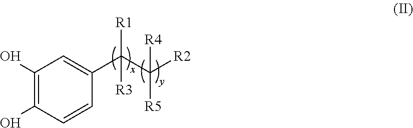

wherein the groups R1, R2, R3, R4 and R5, x and y are as defined for formula (I).

More particularly, the compound the polymerisation of which results in a polydopamine derivative is selected from norepinephrine (compound of formula (II) wherein R1=OH, R2=NH₂ and R3=R4=R5=H), 3,4-dihydroxy-L-phenylalanine (compound of formula (II) wherein R1=R3=R5=H, R2=COOH and R4=NH₂), 3,4-dihydroxy-L-phenylalanine methyl ester (compound of formula (II) wherein R1=R3=R5=H, R2=COOCH₃ and R4=NH₂) and one of salts thereof.

During step (b) of the method according to the invention, an oxidative autopolymerisation of dopamine, of one of the derivatives thereof or of one of the salts thereof is implemented. More particularly, step (b) of the method according to the invention comprises at least one operation consisting in bringing the surface provided during step (a) in contact, under oxidising conditions, with a solution containing a dopamine, one of the derivatives thereof or one of the salts thereof, whereby a coating based on polymers of polydopamine or of one of the derivatives thereof is deposited on said surface. The solution containing a dopamine, one of the derivatives thereof or one of the salts thereof is hereinafter designated solution Sb.

A person skilled in the art knows various oxidising conditions that can be used for obtaining the oxidative autopolymerisation of dopamine, of one of the derivatives thereof or one of the salts thereof. Advantageously, these oxidising conditions may consist of (i) at least one oxidising agent present in solution Sb, said oxidising agent being notably selected from ammonium persulfate, sodium periodate, copper(II) sulfate, sodium perchlorate or one of the mixtures thereof; (ii) an oxygenated or aerated solution Sb, the oxygen, in this variant, fulfilling the role of oxidising agent, or (iii) a alkaline solution Sb, i.e. a solution Sb the pH of which is higher than 8 and notably higher than or equal to 8.5. Typically, the oxidising conditions during the autopolymerisation operation of step (b) consists in using an alkaline solution containing a dopamine, one of the derivatives thereof or one of the salts thereof.

Advantageously, during the autopolymerisation operation of step (b) of the method according to the invention, the solvent of the solution Sb is an aqueous solvent, and this whatever the oxidising conditions used.

Typically, during the autopolymerisation operation of step (b) of the method according to the invention, the solution Sb is not subjected to any stirring.

On the basis of his knowledge and of routine work, a person skilled in the art would be able to determine the quantity of dopamine, of the derivative thereof or of one of the salts thereof, the quantity of oxidising agent and the duration of the autopolymerisation operation during the step (b) without demonstrating any inventive effort.

In a first embodiment, a polymer of polydopamine or of a polydopamine derivative has, i.e. directly carries, at least one —Y function. In other words, at least one —Y function is covalently bonded to an atom of the main chain or skeleton, to an atom of a side chain or to an atom of a pendant group of the polydopamine or polydopamine-derivative polymer.

In a first variant of this first embodiment, the dopamine, one of the derivatives thereof or one of the salts thereof present in the solution Sb carries a —Y function as previously defined. For example, the —Y function may be or may substitute at least one group among the groups R1, R2, R3, R4 and R5 as previously defined. Thus, in this first variant, the step (b) of the method according to the invention corresponds to the operation of oxidative autopolymerisation of a dopamine, of one of the derivatives of or of one of the salts thereof as previously defined.

In a second variant of this first embodiment, the dopamine, one of the derivatives thereof or one of the salts thereof present in the solution Sb does not carry a —Y function as previously defined. The —Y functions are added after the oxidative autopolymerisation by replacing one or more functions, identical or different, substituting the polymer of dopamine or of dopamine derivative by one or more —Y functions by means of one or more simple chemical reactions. In this second variant, the step (b) of the method according to the invention comprises the operation of oxidative autopolymerisation of a dopamine, of one of the derivatives thereof or one of the salts thereof as previously defined following by an operation during which a function or a plurality of functions, identical or different, substituting the dopamine or dopamine-derivative polymer is/are replaced by one or more —Y functions as previously defined. By way of examples of simple chemical reaction that can be used for this substitution, mention can be made of a radical substitution or a nucleophilic addition.

In a second embodiment, the polymer of polydopamine or of a polydopamine derivative indirectly carries at least one —Y function. In other words, the polymer of polydopamine or of a polydopamine derivative carries a molecule, the latter carrying at least one —Y function as previously defined. “Molecule carrying a —Y function” means any natural or synthetic molecule, advantageously organic, comprising from a few atoms to several tens or even hundreds of atoms. This molecule may therefore be a simple molecule or a molecule having a more complex structure such as a polymer structure. Whatever the structure of this molecule is, the essential features in the context of the present invention are the fact that:
on one hand, the molecule is covalently bonded to the polymer of polydopamine or of a polydopamine derivative used, by means of a bond involving an atom of said molecule and an atom of said polymer, said molecule therefore comprises a function involved in the covalent bond with the polydopamine or polydopamine-derivative polymer;
on the other, the molecule comprises a —Y function as previously defined.

It is clear to a person skilled in the art that the function of formula —Y is different from the function involved in the covalent bond with the polymer of polydopamine or of a polydopamine derivative.

In a first variant of this second embodiment (the case of simple molecules), the molecule carrying at least one —Y function is grafted, covalently, on the polymer of polydopamine or of a polydopamine derivative by post-functionalisation of this polymer. In this first variant, the step (b) of the method according to the invention comprises the operation of oxidative autopolymerisation of a dopamine, of one of the derivatives thereof or of one of the salts thereof as previously defined followed by an operation during which the molecule carrying at least one or more —Y functions as previously defined is grafted, covalently, onto the polymer of polydopamine or of a polydopamine derivative by post-functionalisation. During this post-functionalisation, a halogenated derivative and notably a chlorinated derivative of the molecule to be grafted may be used. The experimental part provides hereinafter an example of such a post-functionalisation.

In a second variant of this second embodiment (the case of complex molecules), one or more polymers carrying at least one or more —Y functions as previously defined is/are grafted, covalently, onto the polymer of polydopamine or of a derivative thereof. Thus, in this second variant, the step (b) of the method according to the invention comprises the operation of oxidative autopolymerisation of a dopamine, of one of the derivatives thereof or of one of the salts thereof as previously defined followed by an operation during which one or more polymers carrying at least one or more —Y functions as previously defined is/are grafted, covalently, onto the polymer of polydopamine or of a derivative thereof. The grafting of polymers implemented during the second variant of the second embodiment is notably a radical chemical grafting, well known in the prior art [14].

The expression “radical chemical grafting” has, in the present invention, the same definition as in the international application WO 2008/078052 [15]. It thus refers to the use of molecular entities possessing an unpaired electron to form bonds of the covalent bond type with the polymer of polydopamine or of one of the derivatives thereof, said molecular entities being generated independently of the polymer of polydopamine or of the derivative thereof on which they are intended to be grafted. The radical reaction therefore leads to the formation of covalent bonds between the polymer of polydopamine or of the derivative thereof and the organic polymer or polymers carrying at least one or more —Y functions.

The organic polymers grafted on the surface of the polymer of polydopamine or of the derivative thereof form an organic layer that can be defined as an organic film or an organic coating grafted on the surface of the polymer of polydopamine or of the derivative thereof.

As envisaged in the international application WO 2008/078052 [15], the monomer units from which each organic polymer comes are units derived from at least one aryl diazonium salt and optionally from at least one radically polymerisable monomer advantageously distinct from an aryl diazonium salt. The first molecular unit of each grafted organic polymer comes from an aryl diazonium salt.

In this second variant of this second embodiment, the grafting operation during step (b) consists in bringing the coated surface obtained following the oxidative autopolymerisation operation of said step (b) in contact with a solution containing at least one aryl diazonium salt and optionally at least one radically polymerisable monomer different from an aryl diazonium salt and subjecting said solution to non-electrochemical conditions, provided that

when said solution does not contain a radically polymerisable monomer, said aryl diazonium salt has at least one —Y function as previously defined,

when said solution contains at least one aryl diazonium salt and at least one radically polymerisable monomer, said aryl diazonium salt and/or said radically polymerisable monomer has at least one function of formula —Y,

whereby radical entities are formed from said aryl diazonium salt and a coating based on polymers, identical or different, having at least one function of formula —Y is grafted, covalently, on said coated surface obtained following said oxidative autopolymerisation operation.

As a reminder and as envisaged in the international application WO 2008/078052 [15], the monomer units from which each organic polymer comes may be units solely derived from one (or more) aryl diazonium salt or salts, and this when no radically polymerisable monomer distinct from an aryl diazonium salt is used.

An aryl diazonium salt is a compound of formula (III):

R—N₂⁺,A⁻ (III)

wherein:
A represents a monovalent anion, and
   R represents an aryl group, optionally substituted, as previously defined.

In the aryl diazonium salts and notably the compounds of formula (III) above, R is, preferably, selected from the aryl groups substituted by electron attracting groups such as NO₂, C(O)H, ketones, CN, CO₂H, NH₂ (in the form of NH₃⁺), esters and halogens. The R groups of the aryl type that are particularly preferred are the carboxyphenyl, aminophenyl, nitrophenyl and phenyl radicals, said radicals optionally being substituted by one or more halogen atoms and in particular fluorine.

In the compounds of formula (III) above, A may in particular be selected from the inorganic anions such as the halides such as I⁻, Br⁻ and Cl⁻, halogenoborates such as tetrafluoroborate, perchlorates and sulfonates and organic anions such as alcoholates and carboxylates.

By way of compounds of formula (III), it is particularly advantageous to use a compound selected from the group consisting of phenyldiazonium tetrafluoroborate, 4-nitrophenyldiazonium tetrafluoroborate, 4-bromophenyldiazonium tetrafluoroborate, 4-aminophenyldiazonium chloride, 4-aminomethylphenyldiazonium chloride, 2-methyl-4-chlorophenyldiazonium chloride, 4-benzoylbenzenediazonium tetrafluoroborate, 4-cyanophenyldiazonium tetrafluoroborate, 4-carboxyphenyldiazonium tetrafluoroborate, 4-acetamidophenyldiazonium tetrafluoroborate, 4-phenylacetic acid diazonium tetrafluoroborate, 2-methyl-4-[(2-methylphenyl)diazenyl]benzenediazonium sulfate, 9,10-dioxo-9,10-dihydro-1-anthracenediazonium chloride, 4-nitronaphtalenediazonium tetrafluoroborate, naphthalenediazonium tetrafluoroborate and hexadecafluoro-octylbenzenediazonium tetrafluoroborate.

In the absence of a radically polymerisable monomer different from an aryl diazonium salt, the reaction solution used during the grafting operation during step (b) of the method according to the invention, hereinafter designated solution Sb′, may contain (i) a single aryl diazonium salt (i.e. a single type of aryl diazonium salt), the latter carrying at least one —Y function as previously designed, or (ii) a plurality of different aryl diazonium salts, i.e. a plurality of type of aryl diazonium salt) among which at least one diazonium salt carries at least one —Y function as previously defined. This also applies when the solution Sb′ has one or more radically polymerisable monomers different from an aryl diazonium salt and none of them carries a —Y function.

In the context of the present invention, just as in the context of the international application WO 2008/078052 [15], the aryl diazonium salt may be either introduced into the solution Sb′ as it stands, or prepared in situ notably in the latter.

When the aryl diazonium salt is prepared in situ, use is advantageously made of a precursor of such an aryl diazonium salt which, generally, has greater stability than the aryl diazonium salt under the same environmental conditions. Arylamines are precursors of aryl diazonium salts. Indeed, by simple reaction, for example with NaNO₂ in an acidic aqueous medium, or with NOBF₄ in an organic medium, it is possible to form the corresponding aryl diazonium salts.

One precursor advantageously used in the context of the present invention is a precursor of aryl diazonium salts of the following formula (IV):

R—NH₂ (IV),

R being as previously defined.

By way of non-limitative examples, one precursor able to be used in the context of the present invention is in particular selected from the group consisting of 4-aminophenylamine (or p-phenylenediamine or 1,4-diaminophenylene), 4-nitrophenylamine, 4-amino-benzoic acid, 4-aminomethylphenylamine and halogenated and notably fluorinated derivatives thereof.

“Radically polymerisable monomer” means a monomer capable of polymerising under radical conditions after initiation by radical chemical entity. Typically, it is a monomer including at least one bond of ethylenic type, i.e. a molecule of the ethylenic type or an ethylenically unsaturated molecule.

Among the latter, vinyl monomers, in particular those described in the international applications WO 2005/033378 and WO 2006/097611 are particularly concerned [16, 17].

According to a particularly advantageous embodiment of the invention, the vinyl monomer or monomers is or are selected from the monomers of the following formula (V):

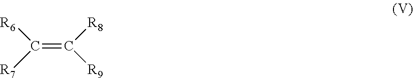

wherein the R6 to R9 groups, identical or different, represent a non-metallic monovalent atom such as a halogen atom, a hydrogen atom, a saturated or unsaturated chemical group, such as an optionally substituted alkyl group, optionally substituted aryl group, a nitrile, carbonyl, amine or amide group or a —COOR10 group wherein R10 represents a hydrogen atom or an alkyl group optionally substituted as previously defined.

The monomers of the above formula (V) are in particular selected from the group consisting of acrylic acid, vinyl acetate, acrylonitrile, methacrylonitrile, the following methacrylates or acrylates: methyl methacrylate (or acrylate), ethyl methacrylate (or acrylate), butyl methacrylate (or acrylate), propyl methacrylate (or acrylate), hydroxyethyl methacrylate (or acrylate), hydroxypropyl methacrylate, glycidyl methacrylate, dimethylamino methacrylate, diethylamino methacrylate and derivates thereof; halogenated methacrylates (or acrylates) of the chloro- or bromo-ethyl methacrylate type, acrylamides and notably amino-ethyl, -propyl, -butyl, -pentyl and -hexyl methacrylamides, cyanoacrylates, di-acrylates and di-methacrylates, tri-acrylates and tri-methacrylates, tetra-acrylates and tetra-methacrylates (such as pentaerythritol tetramethacrylate), styrene and derivatives thereof, parachloro-styrene, pentafluoro-styrene, N-vinyl pyrrolidone, 4-vinyl pyridine, 2-vinyl pyridine, vinyl, acryloyl or methacryloyl halides, di-vinylbenzene, and more generally vinyl cross-linking agents or cross-linking agents based on acrylate, methacrylate and derivatives thereof.

When none of the aryl diazonium salt or salts present in the solution Sb′ carries a —Y function as previously defined, this solution comprises at least one radically polymerisable monomer different from an aryl diazonium salt carrying at least one —Y function as previously defined. In a particular embodiment, the solution Sb′ comprises at least one aryl diazonium salt carrying at least one —Y function and at least one radically polymerisable monomer different from an aryl diazonium salt carrying at least one —Y function, identical to or different from the function carried by the aryl diazonium salt.

When a radically polymerisable monomer different from an aryl diazonium salt carries a —Y function, the latter may correspond to one of the R6 to R9 groups as previously defined or a function substituting one of the R6 to R9 groups as previously defined.

The quantity of aryl diazonium salts, of precursors of aryl diazonium salts, and of radically polymerisable monomers that can be used in the solution Sb′ is in accordance with the quantities envisaged in the international application WO 2008/078052 [15]. Likewise, through routine work, a person skilled in the art will, without any inventive effort, be able to determine the duration of the grafting operation during step (b) of the method according to the present invention.

Finally, the solution Sb′ used in the context of the present invention is a liquid solution that may contain, as solvent, a solvent that may be:
either a protic solvent, i.e. a solvent that includes at least one hydrogen atom able to be released in proton form and advantageously selected from the group consisting of water, deionised water, acidified or basic distilled water, acetic acid, hydroxylated solvents such as methanol and ethanol, liquid glycols of low molecular weight such as ethylene glycol, and mixtures thereof;
or an aprotic solvent, i.e. a solvent that is not able to release a proton or to accept one under non-extreme conditions and advantageously selected from dimethylformamide (DMF), acetone, acetonitrile and dimethyl sulfoxide (DMSO);
or a mixture of at least one protic solvent and at least one aprotic solvent.

The solution Sb′ used in the context of the present invention may also contain one (or more) surfactant(s) in particular selected from the group consisting of anionic surfactants, cationic surfactants, zwitterionic surfactants, amphoteric surfactants and neutral (non-ionic) surfactants and in particular the surfactants described in the international application WO 2008/078052 [15]. Typically the surfactant concentration, when present, will be between 0.5 mM and 5 M approximately, preferably between 0.1 mM and 150 mM approximately.

In the grafting operation during step (b) of the method according to the invention, the bringing of the surface obtained following the oxidative autopolymerisation operation in contact with the solution Sb′ and the application of the non-electrochemical condition may be implemented simultaneously or one after the other. In the latter case, the non-electrochemical condition is typically applied once the bringing in contact has been implemented.

All the non-electrochemical conditions envisaged in the international application WO 2008/078052 [15] and in particular described on page 16, line 4 to page 27, line 24 can be used in the context of the grafting operating during step (b) of the present invention. As a reminder, such non-electrochemical conditions are conditions that allow the formation of radical entities from an aryl diazonium salt in the absence of the application of any electrical voltage to the solution containing it, to the polymer of polydopamine or of the derivative thereof, or to the surface on which the polymer of polydopamine or of the derivative thereof is deposited. These conditions involve parameters such as, for example, the temperature, the nature of the solvent in the reactive solution, the presence of a particular additive, the stirring and the pressure, whereas the electric current does not act during the formation of the radical entities.

The conditions allowing the formation of radical entities are numerous and this type of reaction is known and studied in detail in the prior art. It is thus for example possible to act on the thermal, kinetic, chemical or photochemical environment of the aryl diazonium salt in order to destabilise it so that it forms a radical entity. It is of course possible to act simultaneously on a plurality of these parameters.

Advantageously, the conditions implemented in the context of the present invention as selected from the group consisting of the thermal conditions, the chemical conditions, the photochemical conditions and the combinations thereof with each other and/or with the kinetic conditions. The conditions implemented in the context of the present invention are more particularly chemical or photochemical conditions, and especially chemical conditions.

In particular, the non-electrochemical condition implemented during step (c) is a chemical condition using a chemical initiator, notably an essentially chemical initiator, in particular an organic reducing agent and more particularly ascorbic acid.

The last step of the method according to the invention, i.e. step (c), consists in covalently grafting polymers of the ionene type onto the polymers (the polymers of polydopamine or of a polydopamine derivative optionally post-functionalised or other polymers) carrying one or more —Y functions obtained following step (b) and forming the coating based on polymers carrying one or more —Y functions.

“Polymer of the ionene type” means, in the context of the present invention, a cationic polymer wherein all or part of the positive charges are provided by quaternary ammoniums present in the main chain of the polymer, said positive charges being separated by hydrophobic segments. Hereinafter and hereinabove, the expressions “polymer of the ionene type”, “ionene” and “polyionene” are equivalent and can used interchangeably.

Any polymer of the ionene type able to be obtained by reacting a diamine and a dihalogen can be used in the context of the present invention.

Advantageously, the diamine present in the solution used in the step (c) of the method according to the invention, hereinafter designated solution Sc, is of formula (VI):

(R13)(R14)N-A-N(R15)(R16) (VI)

wherein
R13, R14, R15 and R16, identical or different, represent a hydrogen atom, an alkyl group optionally substituted or an aryl group optionally substituted;
A is a chain chosen from the group consisting of an alkylene chain optionally substituted, an alkenylene or alkynylene chain optionally substituted, an arylene chain optionally substituted, an alkylarylene chain optionally substituted and an arylalkylene chain optionally substituted.

By way of particular examples of alkyl groups that can be used for R13 to R16, mention can be made of the methyl, ethyl, n-propyl, isopropyl, butyl, isobutyl, sec-butyl, Cert-butyl, pentyl, isopentyl, hexyl, heptyl, octyl and nonyl groups.

By way of particular examples of aryl groups that can be used for R13 to R16, mention can be made of the phenyl, biphenyl, naphthyl, anthracenyl, cyclopentadienyl, pyrenyl or naphthyl groups.

“Alkylene chain” means, in the context of the present invention, an alkylene chain, linear, branched or cyclic, comprising from 1 to 30 carbon atoms, in particular from 1 to 20 carbon atoms and in particular from 1 to 15 carbon atoms, said alkylene chain optionally being able to comprise at least one heteroatom. By way of examples of alkylene chains that can be used in the invention, mention can be made of a methylene, ethylene, propylene, butylene, pentylene, hexylene, heptylene, octylene, decylene, undecylene, dodecylene chain and a chain of formula —(CH₂)ₙ—O—(CH₂)ₘ— or —(CH₂)ₙ—S—(CH₂)ₘ— with n and m, identical or different, representing 0 or an integer number between 1 and 20 and with n+m greater than or equal to 1.

“Alkenylene or alkynylene chain” means, in the context of the present invention, an alkenylene or alkynylene chain, linear, branched or cyclic, comprising from 2 to 30 carbon atoms, especially from 2 to 20 carbon atoms and in particular from 2 to 15 carbon atoms, said alkenylene or alkynylene optionally being able to comprise at least one heteroatom.

“Arylene chain” means, in the context of the present invention, any chain comprising an aromatic ring or a plurality of aromatic rings, identical or different, bonded or connected by a simple bond or by a hydrocarbon chain, an aromatic ring having from 3 to 20 carbon atoms, especially from 3 to 14 carbon atoms and in particular from 3 to 8 carbon atoms and optionally being able to comprise a heteroatom. By way of examples of arylene chains that can be used in the invention, mention can be made of a phenylene or biphenylene chain.

“Alkylarylene chain” means, in the context of the present invention, any chain derived from an arylene chain as previous defined, wherein a hydrogen atom is replaced by an alkyl group as previously defined.

“Arylalkylene chain” means, in the context of the present invention, any chain derived from an alkylene chain as previously defined wherein a hydrogen atom is replaced by an aryl group as previously defined.

“Substituted alkylene chain”, “substituted alkenylene or alkynylene chain”, “substituted arylene chain”, “substituted alkylarylene chain” and “substituted arylalkylene chain” means, in the context of the present invention, an alkylene chain, an alkenylene or alkynylene chain, an arylene chain, an alkylarylene chain and an arylalkylene chain as previously defined substituted by a group or a plurality of groups, identical or different, selected from the group consisting of a carboxyl; a carboxylate; an aldehyde; an ester; an ether; a ketone; a hydroxyl; an alkyl optionally substituted; an amide; a sulfonyl; a sulfoxide; an sulfonic acid; a sulfonate; a nitrile; a nitro; an acyl; a vinyl; an epoxy; a phosphonate; an isocyanate; a thiol; a glycidoxy; and an acryloxy.

In a particular embodiment, the R13, R14, R15 and R16 radicals are identical. In a more particular embodiment, the R13, R14, R15 and R16 radicals are identical and represent a methyl or an ethyl.

Advantageously, the dihalogen present in the solution Sc is of formula (VII):

(R17)-B—(R18) (VII)

wherein
R17 and R18, identical or different, represent a halogen; and
B is a chain selected from the group consisting of an alkylene chain optionally substituted, an alkenylene or alkynylene chain optionally substituted, an arylene chain optionally substituted, an alkylarylene chain optionally substituted and an arylalkylene chain optionally substituted.

In a particular embodiment, the R17 and R18 radicals are identical. In a more particular embodiment, the R17 and R18 radicals are identical and represent a bromine atom, a chlorine atom or an iodine atom. In an even more particular embodiment, the R17 and R18 radicals are identical and represent a bromine atom.

The chemical reaction implemented in step (c) is a polyaddition, also known by the expression “Menschutkin reaction”. The R13, R14, R15 and R16 functions carried by the diamine and the R17 and R18 functions carried by the dihalide are reactive functions in this reaction. However, in the presence of the adherent and/or grafted polymers following step (b), i.e. polymers carrying one or more —Y functions, and because of the definition of such functions, these are also reactive functions in the polyaddition reaction which causes the creation of covalent bonds between the adherent and/or grafted polymers following step (b) and the polymers of the polyionene type during step (c). In other words, all or some of the —Y functions carried by the adherent and/or grafted polymers following step (b) have been replaced by covalent functions bonding these polymers to the polymers of the polyionene type following step (c).

Step (c) is implemented at a temperature higher than ambient temperature. “Ambient temperature” means a temperature of 23° C.±5° C. Advantageously, the temperature in step (c) is above 30° C. Typically, the temperature in step (c) is between 40° C. and 80° C., in particular between 55° C. and 75° C., and more particularly is of the order of 65° C. (i.e. 65° C.±5° C.).

Advantageously, the solvent of the solution Sc is a polar, protic or aprotic solvent. The solvent of the solution Sc is especially a hydroxylated solution and in particular methanol or ethanol.

By routine work a person skilled in the art will be able, without any inventive effort, to determine the quantity of diamine and halide to be used according in particular to the solubility thereof in the solution Sc as well as the duration of step (c). By way of example, this duration may be between 6 hours and 30 hours, notably between 12 hours and 24 hours and in particular of the order of 16 hours (i.e. 16 hours±2 hours).

In the context of the method according to the invention, it may be necessary to eliminate, before the following step, any compound of the current step that has not reacted and/or is liable to affect the following steps. Consequently at least one washing step followed by a rinsing step exists between step (a) and step (b), between the various operations during step (b) and/or between step (b) and step (c). It is thus possible to perform, between step (a) and step (b), between the various operations in step (b) and/or between step (b) and step (c), one, two, three, four or five washings with identical or different solutions, before the drying step. The washing solution is notably selected from the group consisting of distilled water, deionised water, MilliQ deionised water, acetone and ethanol. Advantageously, the drying step is implemented under nitrogen. The following experimental part proposes sequences of washing steps followed by a drying step, applicable to any method according to the invention.

The present invention also relates to an object having a surface to which bacteriostatic or bactericidal properties have been imparted in accordance with the method as previously defined. Everything that has previously been described for the object and the surface thereof also applies to this aspect of the invention.

Finally, the present invention relates to the use of such an object for packaging and/or preserving food products as fresh food products. The coatings may also make it possible to preserve a flora of technological interest and to eliminate an undesirable flora such as a spoilage or pathogenic flora.

The invention also relates to the use of such an object for purifying and/or decontaminating a solution, an object or a surface, and this notably in the environmental or health field.

Other features and advantages of the present invention will also be clear to a person skilled in the art from a reading of the following examples given by illustrative and non-limitative way, with reference to the appended figures.

### BRIEF DESCRIPTION OF THE DRAWINGS

FIG. 1 presents a schematisation of the surface-chemistry method for preparing glass or PE surfaces, grafted with ionenes, in accordance with an embodiment of the invention.

FIG. 2 presents the FTIR spectra of the external layer at various steps of the surface-chemistry procedure: polydopamine (PDOPA), poly(dimethylaminoethyl methacrylate) (PDMA), polyionene 6,6 (PI 6,6).

FIG. 3 presents the spectra of XPS measurements of the various layers: (A) polydopamine (PDOPA), (B) poly(dimethylamino methacrylate) (PDMA), (C) polyionene 3,3 (PI 3,3), (D) polyionene 6,6 (PI 6,6) and (E) polyionene 6,12 (PI 6,12).

FIG. 4 presents the high-resolution XPS spectra of nitrogen N 1s for the various layers: (A) polydopamine (PDA), (B) poly(dimethylamino methacrylate) (PDMA), (C) polyionene 3,3 (PI 3,3), (D) polyionene 6,6 (PI 6,6) and (E) polyionene 6,12 (PI 6,12).

FIG. 5 presents the high-resolution XPS spectra of nitrogen N 1s for the various layers: PE film (PE), polydopamine (PE-PDOPA) and polyionene 3,3 (PE-PI).

FIG. 6a presents the viable cultivable count by UFC of strains of S. aureus on glass surfaces modified with poly(dimethylaminoethylmethacrylate, polyionene 3,3, polyionene 6,6, polyionene 6,9 and polyionene 6,12.

FIG. 6b presents the inhibition percentage of the bacteria (S. aureus) for each type of grafted polyionene film with native glass as reference.

FIG. 7 presents the efficacy percentage (viable/cultivable) of each type of grafted polyionene film with as reference the bacteria (S. aureus) initially adhered to the films.

FIG. 8 presents the optical density curves of the various concentrations of supernatants of the substrates modified with PI 3,3.

FIG. 9 presents the viable cultivable count by UFC of strains of S. aureus on glass surfaces modified with poly(2-methacryloyloxy)ethyltrimethylammonium chloride) (PMTAC), polyionene 3,3 (PI 3,3) and polyionene 6,6 (PI 6,6).

FIG. 10a presents the analysis of the first bath for methanol cleaning of a PE surface grafted with PI 6,6 by exclusion chromatography coupled with the measurement of the diffusion of light at multiple angles (SEC-MALS).

FIG. 10b presents the analysis of the second bath for methanol cleaning of a PE surface grafted with PI 6,6 by SEC-MALS.

FIG. 10c presents the analysis of the third bath for methanol cleaning of a PE surface grafted with PI 6,6 by SEC-MALS.

### DETAILED DESCRIPTION OF PARTICULAR EMBODIMENTS

### I. Material and Methods

All the reagents were obtained from Aldrich Chemical Co and were used as received. The glass plates (3.25 cm²) were received from Thermo-Fisher. The polyethylene (PE) films were supplied by the Plastics Division of Bolloré.

### I.1. Activation of the Glass or PE Surfaces

The glass plates were washed with an oxidising piranha solution (H₂SO₄/H₂O₂ 75/25) for 30 min, before being rinsed with a large volume of Milli-Q deionised water and dried under nitrogen.

The PE films previously coronated at the manufacturer are “reactivated” via a plasma treatment with the following conditions: O₂/Ar gas mixture (95/5) for 5 min.

### I.2. Coating Based on Polydopamine on Glass or PE Surfaces (PDOPA-Glass or PDOPA-PE)

The activated glass surfaces were next dipped in an aqueous solution of dopamine (1 mg/mL with a pH adjusted to 11 using 1M NaOH) from 1 hour to 48 hours without stirring. After this treatment, the glass plates were next rinsed with Milli-Q deionised water and ethanol. To finish, the samples are dried under nitrogen.

On the PE films, more concentrated dopamine solutions may be used (3 to 7 mg/mL) and the pH adjusted to 8.5 with a Tris-HCl (10 mM) solution. The operating conditions used in this case are inspired by Ryu et al, 2018 [18]. The same washing as on the glass are implemented before passing to the following step.

### I.3. Introduction of the Dimethylamino Functions

### i. Grafting of Poly(Dimethylaminoethylmethacrylate) on the Glass or PE Surfaces (PDMA-Grafted Surfaces)

The polymerisation of the dimethylaminoethylmethacrylate (DMA) was implemented according to the Graftfast™ method. The nitrobenzene diazonium salt was synthesised in-situ from nitroaniline (0.551 g) in 20 mL of 0.5 M HCl and sodium nitrite (0.276 g) in 12 mL of 0.5 M HCl. The reaction was left under stirring for 10 min. A solution of DMA (86.7 mg/ml) in DMF is added dropwise to this mixture of nitroaniline and sodium nitrite. The glass surfaces coated with PDOPA were next placed horizontally on a grid and then covered with the prepared solution. The polymerisation was initiated by introducing a solution of a reducing agent (L-ascorbic acid at 9 mg/mL) in water. After one hour, the reactive solution is removed and the samples are next rinsed with acetone, deionised water and ethanol, before being dried under nitrogen. The same protocol is used for PE films coated with PDOPA.

### ii. Post-Functionalisation of the Polydopamine Film

In a reactor conditioned under nitrogen, the glass plates or the PE films are introduced before adding THF (28 mL) and 4 g of DMABC (4-(dimethylamino)benzoyl) chloride. The reaction mixture under stirring is lightly heated (hot-water bath) to favour the dilution of all the DMABC. Next, triethylamine (7 mL) is added dropwise, which leads to a brown-coloured clouding of the solution. The mixture is then left under stirring for 24 h. The plates are next washed with water and ethanol and then dried under nitrogen. The effective grafting of DMABC is proved by measuring contact angles (θ_{DOPA} greater than 10° and θ_{DOPA+DMABC} approximately 60°), and with XPS.

### I.4. Grafting of Polyionenes (PI)

The polymerisation of the polyionenes (polyaddition) was implemented in a methanol solution at 65° C. for 16 h, directly using the surfaces (PE or glass) grafted with PDMA, placed horizontally on the grid. The two monomers (dibromine and diamine) were next added to the solution at a concentration of 0.9 M. Five different polyionene surfaces were prepared: polyionene 3,3 (PI 3,3) using N,N,N′,N′-tetramethyl-1-3 propane diamine and 1,3-dibromopropane; polyionene 6,6 (PI 6,6) using N,N,N′,N′-tetramethyl-1,6 hexanediamine and 1,6-dibromohexane; polyionene 6,Ph (PI 6,Ph) using N,N,N′,N′-tetramethyl-1,6 hexanediamine and α,α′-dibromomethyl-p-xylene; polyionene 6,9 (PI 6,9) using N,N,N′,N′-tetramethyl-1,6 hexanediamine and 1,9 dibromononane, and polyionene 6,12 (PI 6,12) using N,N,N′,N′-tetramethyl-1,6 hexanediamine and 1,12-dibromododecane. After the reaction, the samples are next rinsed several times with deionised water and ethanol and then dried under nitrogen. Similar conditions were implemented on the post-functionalised polydopamine films.

### I.5. Characterisation of the Surfaces

At each reaction step, the surface was characterised by FTIR, XPS, profilometer, measurements of contact angles and energetic surface characteristics, the untreated glass plate or the initial PE film serving as a reference.

The infrared spectra were obtained with a Bruker Vertex 70 and a DTGS detector at ambient temperature.

The XPS measurements were obtained using a Kratos Axis Ultra DLD spectrometer with monochromatic Al K excitation (1486.7 eV) at 150 W and a charge compensation system. The photoelectronic data were collected at an output angle of 90°. The spectra of the study were taken at a pass energy of the analyser of 160 eV and the high-resolution spectra at a pass energy of 40 eV. The binding energy scale was calibrated on the C 1s line at 284.7 eV.

The measurements of the contact angles were evaluated with an APOLLO apparatus, AC01 OCA Data Physics, at ambient temperature. The mean values were obtained from five measurements made on various points of the plate. The thicknesses of the films were determined using a Dektak 30ST profilometer with a vertical resolution of 3 nm.

The energetic characteristics of the surfaces were determined by measuring the contact angles (θ) with a method proposed by Young-van Oss et al. In this approach, the contact angles (θ) of the pure liquid (L) can be expressed as follows [19]:

$$cos θ = - 1 + \frac{2 {( {γ}_{S}^{L W} + {γ}_{L}^{L W} )}^{\frac{1}{2}}}{{γ}_{L V}} + \frac{2 {( {γ}_{S}^{+} {γ}_{L}^{-} )}^{\frac{1}{2}}}{{γ}_{L V}} + \frac{2 {( {γ}_{S}^{-} {γ}_{L}^{+} )}^{\frac{1}{2}}}{{γ}_{L V}} \qquad ( 1 )$$

wherein γ^{LW} designates the Lifshitz-van der Waals component of the surface free energy, γ⁺ the electron-accepting component and γ⁻ the electron-donating component of the surface free energy. The acid-Lewis base property (γ^{AB}) and the total surface free energy (γ) were defined respectively by:

$$\begin{matrix}{γ}^{A B} = 2 {( {γ}^{+} {γ}^{-} )}^{\frac{1}{2}} & ( 2 ) \\ γ = {γ}^{L W} + {γ}^{A B} & ( 3 )\end{matrix}$$

Three liquids having known energetic characteristics were used: water (Millipore, France), formamide, di-iodomethane and/or bromonaphthalene. For each solvent and each sample, at least 10 measurements were taken on each surface.

### I.6. Ionenes in Solution

The polyionenes were synthesised according to the procedure described in [20]. The molar masses were characterised by ¹H NMR and by aqueous exclusion chromatography (SEC), with 2 PolarGel-M columns (300×7.5 mm) from Varian and the eluent containing 54% by volume of a 0.54 M solution of sodium acetate, 23% by volume methanol, 23% by volume glacial acetic acid, with a global pH of 4. Detection was made via a 390-LC system (DRI+viscometer+15/90 double-angle light diffusion detector) with EasiVial polyethylene glycol/oxide standards, of narrow polydispersity, for calibration.

### I.7. Microbial Equipment

Two strains of Lactococcus lactis (one hydrophilic strain (505) and one hydrophobic strain (507)), Staphylococcus aureus (S. aureus) and Escherichia coli (E. coli) were respectively cultured in a M17 medium (Becton Dickinson), in a TSB (Trypcase Sofa Broth) medium and in an LB (Luria Bertani) medium. The strains were cultured with three consecutive culture batches at 30° C. for L. lactis and at 37° C. for S. aureus and E. coli. The experiments were carried out using cultures in stationary phase with an optical density at 620 nm (OD_{620 nm}) of 0.8 (approximately 10⁹ units forming colonies per ml (UFC·mL⁻¹)).

### I.8. Minimum Inhibitory Concentration (MIC)

The MIC was estimated from turbidity growth curves generated by an automatic spectrophotometer (Bioscreen C™, Labsystem France SA). The MIC signifies the lowest concentration of the compound that completely inhibits growth. All the available strains were tested in the presence of various polyionenes. The Bioscreen C™ apparatus has a microbiological incubator and a device for monitoring the growth of the cultures affording simultaneous analysis of 200 samples distributed in two microplates of 10×10 wells. By measuring the turbidity of the bacterial suspension over time, the bacterial growth can be obtained from the optical density (OD) curve. In the present case, the measurements were made at a wavelength of 600 nm. Each well of the Bioscreen plate was inoculated with 270 μl of bacterial suspension in M17 or TSB medium at 10⁶ UFC·mL⁻¹ (this concentration was checked by gelose-medium count) and 30 μl of the polymer solution. Next, the wells were carefully mixed and the entire plate was passed through the Bioscreen for 72 hours at 30° C. or 37° C. according to the tested bacteria. Bioscreen was programmed for measuring the OD of each well every 15 min, stirring the plate with a moderate intensity for 30 seconds before the measurements.

### I.9. Bacterial Adhesion Tests

The bacterial adhesion tests were performed by sedimentation using the two pathogen strains: Staphylococcus aureus and Escherichia coli.

The cells in the stationary phase of growth were harvested and washed three times by centrifugation at 7000 g for 10 minutes at 4° C. and once again suspended in sterile distilled water. The cells were adjusted to OD_{620 nm}≈0.8 and the concentration was checked by viable cultivable cell count on TS Agar plates. 10 ml of the cell suspension was left to adhere for 3 hours at 37° C. to substrate samples in 55 mm Petri dishes. After 3 hours the cells that were non-adherent or only weakly bound were eliminated by 6 successive rinses of substrate samples in deionised water. The adherent cells were detached by ultrasound treatment (Branson Ultrasonics 1510, USA) for 2 minutes at ambient temperature and under vigorous stirring for 30 seconds at ambient temperature. The number of viable and cultivable bacteria was determined by counting the cultivable cells on TS Agar plates. Each experiment was repeated three times. ANOVA variance analysis was carried out using Statgraphics (Manugistic Inc., Rockville, Md., USA). The inhibition percentage of the growth of the bacteria on the fluorinated surfaces with regard to the bare glass surface by way of reference was calculated with the following formula:

% Inhibitionₛₐₘₚₗₑ=(1−(UFCₛₐₘₚₗₑ/UFC_{reference}))×100

with “sample” corresponding to the polyionene grafted surfaces and “reference” corresponding to the glass plates or surfaces of PE. Moreover, in the above formula, “UFC” means Units Forming Colonies per surface unit expressed in cm².

For the observations of the total flora, the contaminated substrate was placed between two plates and observed with a Leica DMLB microscope. With regard to S. aureus, epifluorescence microscopy was implemented directly using a fluorescent strain.

For the adhesion tests relating to E. coli, the colouring method using the LIVE/DEAD® BacLight™ kit was used. This colouring test makes it possible to directly distinguish the total and inhibited flora. It is based on two fluorescent sensors: cyto 9 sensitive to the total flora by penetrating the membranes of both the living and the dead cells and propidium iodide selective of the membranes of dead cells. Epifluorescence microscopy was used once again for estimating the adhesion of the bacteria and for calculating the viability percentage.

### II. Results and Discussion

### II.1. Physical and Biological Studies of Ionenes in Solution (Non-Grafted)

The particularly effective bacteriostatic properties of polyionenes (PI) has already been demonstrated recently [7], but no systematic study has been carried out on aliphatic PIs having a different chain length. In addition, the strains of interest selected here also had to be studied here in solution (MIC “minimum inhibitory concentrations” measurements) before being used in adhesion studies on surfaces grafted with PIs.

For this purpose several polymers having a different hydrophobicity/charge ratio were synthesised. A similar study was carried with other polymers (polycarbonates) [21]. As indicated previously, the synthesis of the ionenes is based on a polyaddition method (Menschutkin reaction) leading to good control of the hydrophobicity/charge ratio, of the charge density and of the chain length. In general, the synthesis involves the reaction of N,N,N′,N′-tetramethyldiamines and α,ω-dibromoalkanes in water or a polar solvent [20]. The typical nomenclature of aliphatic ammonium ionenes is x,y-ionene where x represents the number of methylene units derived from the tertiary diamine monomer and y represents the methylene units in the dihalogenoalkane monomer. The structure is principally characterised by ¹H NMR from which it is also possible to calculate the molar mass (Mn) as a function of the ratio of the integrations of the signals of the chain ends and those due to the repeating units of the polymer chain (Tableau 1). Aqueous steric exclusion chromatography (SEC) was also used and the analysis gave an Mn varying from 2,500 to 12,000 g·mol⁻¹ with a polydispersity of 1.3 to 3 (see Table 1).

To determine the bacteriostatic properties of the polyionenes, measurements of minimum inhibitory concentration (MIC) were made. The MIC is the lowest concentration of an antimicrobial material capable of inhibiting the visible growth of a microorganism. Here it characterises the bacteriostatic effect of the polyionenes. Tests were also carried out on Saccharomyces aureus initially and supplementary measurements were also carried out on strains of Lactococcus lactis (Gram+) as well as on a strain of Escherichia coli (Gram −). All the results were set out Table 1 below. The MIC results are expressed in μg/ml and poly(2-methacryloyloxy)ethyltrimethylammonium) chloride (PMTAC) is used by way of comparison since it is a cationic polymer that is normally used for antibacterial applications [22, 23].

TABLE 1

| | Mₙ | | MIC | MIC | MIC | MIC |
|---|---|---|---|---|---|---|
| | (g · mol⁻¹) | | (μg/mL) | (μg/mL) | (μg/mL) | (μg/mL) |
| Polyionene | (PDI) | | L. lactis 505 | L. lactis 507 | S. aureus | E. coli |
| PI 3,3 | 6000 | (2.4) | 75 | 60 | 15 | 50 |
| PI 6,6-1 | 11200 | (1.3) | 25 | 27 | 7.5 | 7.5 |
| PI 6,6-2 | 10800 | (1.6) | 25 | 27 | 7.5 | 7.5 |
| PI 6,Ph | 9500 | (3) | 15 | 15 | 15 | / |
| PI 6,9-1 | 12000 | (1.6) | 15 | 3.75 | 15 | / |
| PI 6,9-2 | 5200 | (1.7) | 15 | 3.75 | 7.5 | 3.75 |
| PI 6,12 | 2900 | (1.3) | 1 | 1 | 2 | 1 |
| PMTAC | 8100 | (1.2) | >200 | >200 | >200 | >200 |

First of all, it can be noted that the MICs of the ionenes are particularly low, but these values are all the lower as the length of the hydrophobic segments increases. This tendency is observed for all the strains studied. With regard to the nature of the strains, it can be shown that the bacteriostatic effects are PI 3,3 and PI 6,6 on S. aureus are more marked than on the two strains of L. lactis. When the hydrophobic segments are larger, the antimicrobial properties are greater with regard to S. aureus than L. lactis. Only the intermediate PI 6,Ph containing phenyl groups inside the segments does not exhibit any variation of MIC on the two strains. It should be noted that generally the MIC values are very similar for the two lactic strains (hydrophilic and hydrophobic). For E. coli, the same tendency is observed, i.e. the MIC values for PI 6,6 (7.5 μg/mL) are lower than for PI 3,3 (50 μg/mL). These data make it possible to establish the hypothesis of a more marked effect of the PIs for undesirable flora (S. aureus and E. coli) than for flora of technological interest. Thus, at the MICs of undesirable flora, preservation of the positive (lactic) strains is possible. This may have an appreciable advantage in particular in the application of food films of meat-based products.

The other point to be emphasised is the great difference between the MIC values between polyionenes and other cationic polymers such as PMTAC obtained by controlled radical polymerisation (atom transfer polymerisation, ATRP). The latter contains pendant cationic groups (quaternary ammonium) and has already been widely mentioned as an antimicrobial polymer [22]. The inventors have clearly measured that the MIC of this polymer is much higher than that of PI (≥200 μg/mL). The main difference between PMTAC and ionenes is based on the structure. Both contain a positive charge (quaternary ammonium) in the repeating units, but in the case of ionenes this positive charge is combined with segments of hydrophobic methylene groups of greater or lesser length. The other particularity of these cationic polymers is the position of the quaternary ammonium inside the skeleton of the chain, conferring better stability on the charges, compared with pendant charged groups (PMTAC) [20].

### II.2. Surface Grafting of Ionenes

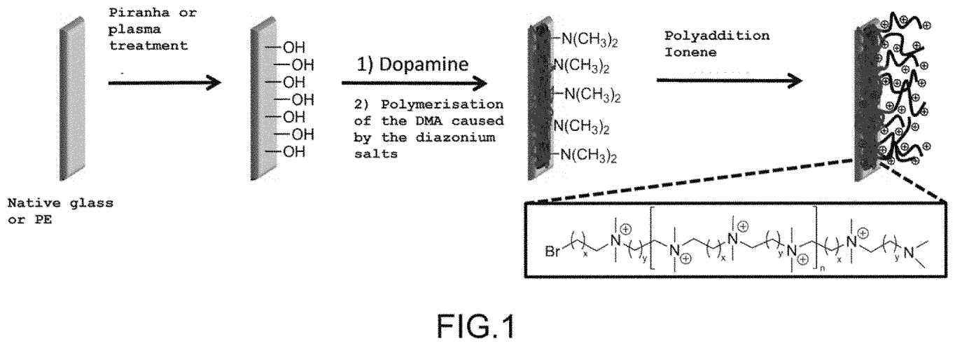

The chemical procedure of grafting on glass plates is shown schematically in FIG. 1 (the same protocol is used on the PE films, only the first activation step differs: this is a corona/plasma treatment). The polyionene grafting strategy has been envisaged by preparing a sublayer of poly(dimethylamino methacrylate) wherein dimethylamino groups can be used advantageously for implementing the polyaddition of the ionenes. This polymerisation was implemented by the Graftfast™ method [14,15], a surface polymerisation induced by the diazonium salts. For the treated surfaces to be treated more homogeneously, a more reactive sublayer based on a polydopamine (PDA) coating was used. The use of this bio-inspired coating material as an adhesion primary coat has, during the past years, emerged thanks to the pioneering works of Messersmith et al [10]. The reaction mechanisms have been studied and reported as involving the formation of Schiff bases, Michael additions and/or supramolecular aggregates of monomers that are held together by a combination of charge transfer interactions, aromatic stacking (n-stacking) and/or hydrogen bond [9-12, 24].

As shown by the diagram in FIG. 1, before the polydopamine (PDOPA) coating, the glass surfaces were activated by immersion in a piranha solution to generate a hydroxyl-rich layer. For the PE films, this activation is implemented via a plasma treatment the conditions of which (gas, duration, etc.) were optimised. Next an autopolymerisation of PDOPA was implemented at pH 11, as described previously in the literature [25]. The PDA solution was left to react for 1 to 48 hours leading to an adherent PDOPA film, deposited on glass plates or PE films.

The strategy next employed is based on a surface polymerisation of (dimethylaminoethyl)methacrylate (DMA) by reducing the diazonium salts and called Graftfast™ (FIG. 1). This method consists in a simple redox activation of the aryl diazonium salts (strong oxidising agents) with a reducing agent such as L-ascorbic acid. This leads to the formation of a layer of the grafted polynitrophenylene (PNP) type when no vinyl monomer is present or to thin grafted polymer films resulting from the reaction with monomers. For the latter, the initiation of the polymerisation is induced by aryl radicals, and the growing polymer chains thus formed can then react on the PDOPA sublayer by radical coupling or by hydrogen absorption [14,15]. The optimum concentration of monomer (DMA) was determined so as to result in the maximum number of growth chains and an optimum film thickness. All the characteristics of this layer (FTIR, XPS and contact angles) will be discussed subsequently and compared with the others in the nanostructured film.

In a variant, the dimethylamino functions can be introduced via the post-functionalisation of PDOPA in accordance with the methods described at point I.3.ii above.

From the layer of poly(dimethylaminoethyl methacrylate) (PDMA), direct polymerisation of ionenes was successfully implemented. Surface polymerisation of ionenes was implemented in methanol at 60° C. during one night. The concentration of monomer and the percentage of solvent were optimised on the basis of the kinetic data in solution and surface polymerisation experiments. The concentration of monomers (diamine and dibromine) was fixed at 0.9 M, the corresponding film thickness for this concentration being maximum. The surface polymerisation was implemented using the same combination of dibromine and diamine as that described previously in solution, leading to the grafting of PI 3,3, PI 6,6, PI 6,9 and PI 6,12. After the reaction, the functionalised glass plates (or other substrates such as PE films) were rinsed with deionised water and then ethanol before being dried under nitrogen. As with the other reaction steps, the characterisation was done via FTIR, measurement of contact angles and XPS.

First of all, the molar mass (Mn) of the grafted ionenes was determined via ¹H NMR and more particularly steric exclusion chromatography coupled with light diffusion (SEC/MALS) of the polymer formed in solution (Table 2).

TABLE 2
Molar masses of polyionenes synthesised in solution,
determined by NMR or steric exclusion chromatography
coupled with light diffusion (SEC/MALS)

| Grafted | Mₙ (g · mol⁻¹) | Mₙ (g · mol⁻¹) | Polydispersity (PDI) |
|---|---|---|---|
| polyionenes | ¹H NMR | SEC/MALS | M_{w}/Mₙ |
| PI 3,3 | 7300 | 3300 | 2.75 |
| PI 6,6 | 4200 | 4300 | 1.8 |
| PI 6,9 | 6100 | 3900 | 1.6 |
| PI 6,12 | 11100 | 7400 | 1.85 |

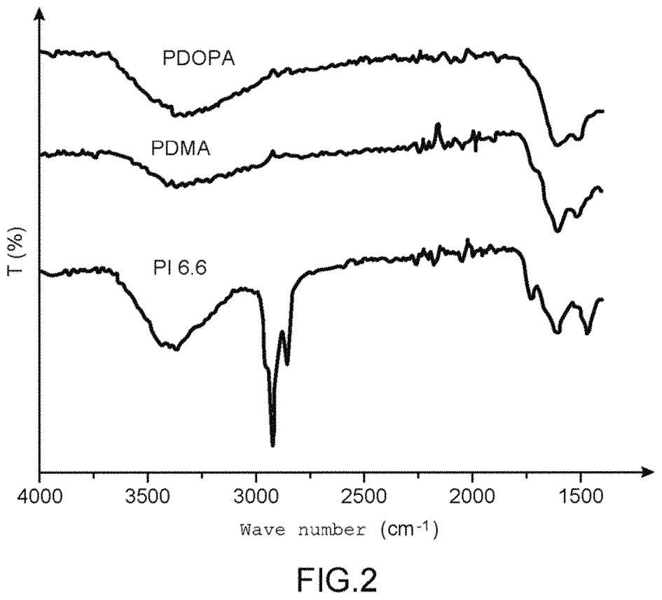

The infrared spectra of the various layers were also measured to attest to the effective grafting thereof (FIG. 2). The polydopamine (PDA) showed a strong absorption band at 3400 cm⁻¹, characteristic of amino groups. The layer of PDMA is next characterised by the presence of the ester band at 1730 cm⁻¹. The various layers of ionene are characterised both by the methylene band at 2900 cm⁻¹ and the band corresponding to the quaternised ammonium groups at 3400 cm⁻¹. Using the abacus produced with PDMA films, a thickness of approximately 8 nm based on the percentage of ester was determined before the polymerisation of the ionenes. After the polymerisation of the ionenes, the profilometer measurements gave a thickness of 17.5 nm (PI 6,6). These values were then confirmed by XPS measurements.

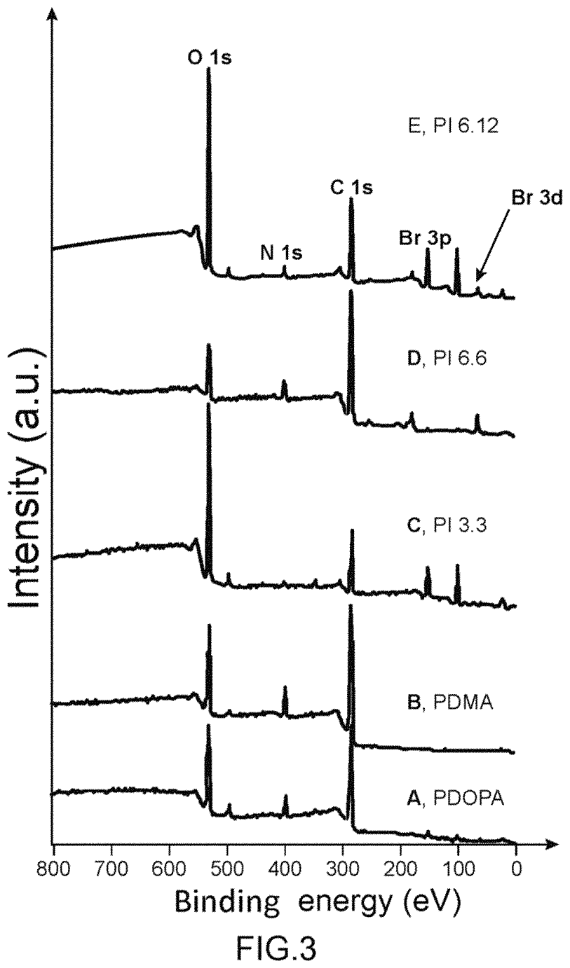

To improve the characterisation of the structures, XPS measurements were also made for the sequenced layers (Table 3, FIGS. 3, 4 and 5). Table 3 summarises the surface atomic compositions deduced from the XPS data.

TABLE 3
Surface chemical composition (% atomic) of the surfaces determined
by XPS, from the spectra together with the % concentration of the
various N 1s bonds from the high-resolution spectra
Atomic ratio (%)

| Layer | N 1 s | C—N | N+ | NO₂ | C 1 s | 0 1 s | Si 2 p |
|---|---|---|---|---|---|---|---|
| PDOPA | 7 | / | / | / | 70 | 31 | 3.5 |
| PDMA | 9 | / | / | / | 74 | 16.5 | 0.5 |
| PI 3,3 | 7 | 59 | 36 | 5 | 72 | 17 | 2 |
| PI 6,6 | 7 | 43 | 55 | 2 | 79 | 13 | 1 |
| PI 6,12 | / | 38 | 57 | 5 | / | / | / |
| PI 6,9 | | 40 | 59 | / | / | / | / |

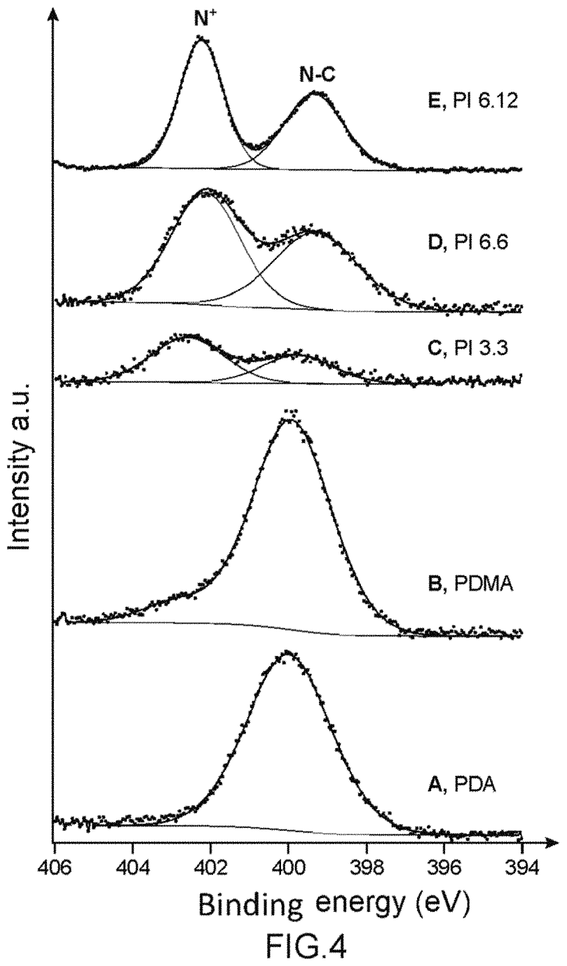

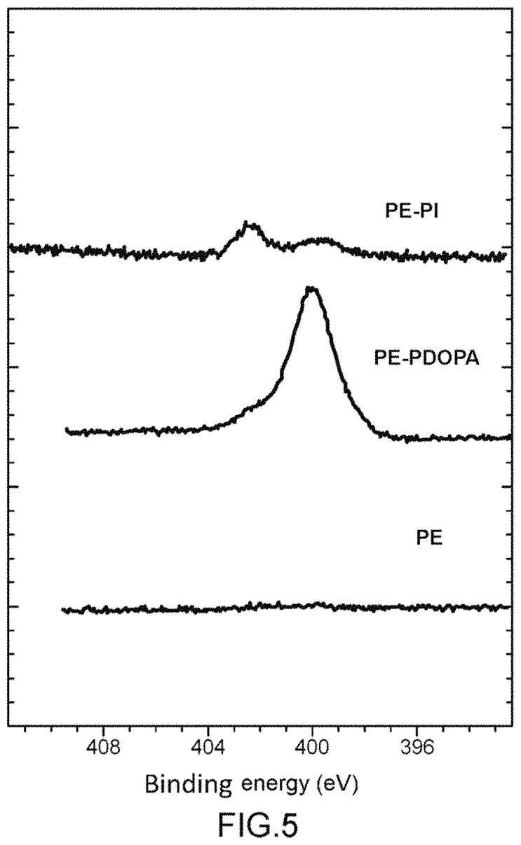

The XPS study of the polydopamine (PDOPA), poly(dimethylamino) methacrylate (PDMA) and ionene surfaces is presented in FIG. 3. For all the layers, the main signals are due to the presence of oxygen, carbon and nitrogen. For the ionene layers, the presence of two bromine signals (Br3p and Br3d) can also be observed, due to the counter-ions of the quaternary ammoniums. Via high-resolution measurements on the nitrogen peaks, respectively made on glass surfaces (FIG. 4) or PE surfaces (FIG. 5), it can be seen that the PDOPA layer and the PDMA layer have only one contribution (a single peak at 400 eV). After the polymerisations of the ionenes, two peaks appear clearly for the N signal. This is a new contribution at a higher bonding energy (402 eV) corresponding to the ammonium groups (N⁺). This peak then represents the signature of the presence of ionenes on the pre-treated glass or PE surfaces.

### II.3. Energy Characterisation of the Ionene Surfaces

Measurements of contact angles with water were first of all made. The values obtained from the polyionene surfaces are lower than those of the PDMA sublayer, which is explained simply by the fact that the polyionene layer is charged, unlike the PDMA one. More surprisingly, the values of the contact angles with water have a tendency to decrease with the presence in the ionenes of longer hydrophobic fragments.

Table 4 below presents the measurements of contact angles with water on activated PE or glass surfaces (pre-treatment), coated with polydopamine (Polydopamine) and then subjected to either radical grafting of PDMA (PDMA film) or a post-functionalisation of the polydopamine (grafting of DMABC) before grafting of polyionene (PI 3,3 grafting). A significant variation in the values of contact angles during the various steps for these two supplementary methods can thus be noted. This, with the XPS data, attests to the effective grafting of the ionenes whether on PE via the PDMA method or on glass via the post-functionalisation of the PDOPA.

TABLE 4
Values of contact angles (with water) of the various steps for
grafting on PE via PDMA or on glass via functionalised PDOPA

| | Polyethylene (PE) | Glass |
|---|---|---|
| | Contact angle | Contact angle |
| | with water (°) | with water (°) |
| Native surface | 84 ± 5 | 26 ± 5 |
| Pre-treatment | 67 ± 2 | 12 ± 3 |
| Polydopamine | <10 | <10 |
| PDMA film | 62 ± 3 | / |
| Grafting of DMABC | / | 61 ± 2 |
| Grafting PI 3,3 | 50 ± 3 | 52 ± 5 |

However, the values of contact angles with water are not sufficient to reach a conclusion on the energy properties of the surface.

Consequently, to better understand the wetting properties of the surfaces, the energy characteristics were determined, for glass surfaces grafted with PIs in accordance with the method according to the invention, using polar and non-polar liquids. Using the Young-van Oss equation, it is possible to calculate respectively the Lifshitz-van der Waals component γ^{LW} (non-polar), the Lewis acid parameter γ⁺ and the Lewis base parameter γ⁻ (Table 5).

TABLE 5
Calculated energy values of solid surfaces (mJ · m⁻²)

| | Parameters (mJ · m⁻²) | | | | | | | |
|---|---|---|---|---|---|---|---|---|
| Glass surface with | γ^{LW} | γ⁻ | γ⁺ | γ^{AB} | γ^{S} | ΔG_{AB} | ΔG_{LW} | ΔG |
| PI 3-3 | 37.5 ± 1.2 | 17.9 ± 7.8 | 2.1 ± 1.2 | 12.2 ± 5.1 | 49.9 ± 5.2 | −57.3 ± 11.5 | −57.3 ± 0.9 | −114.7 ± 11.5 |
| PI 6-6 | 42.7 ± 1.5 | 35.1 ± 4.7 | 1.5 ± 0.4 | 14.3 ± 2.7 | 57.0 ± 3.1 | −72.0 ± 5.3 | −61.0 ± 1.1 | −133.0 ± 5.4 |
| PI 6-9 | 45.1 ± 1.4 | 32.9 ± 3.7 | 1.1 ± 0.3 | 12.1 ± 2.2 | 57.1 ± 2.6 | −68.6 ± 4.4 | −62.7 ± 1.0 | −131.3 ± 4.5 |
| PI 6-12 | 41.5 ± 0.3 | 45.8 ± 3.3 | 1.4 ± 0.2 | 15.7 ± 1.6 | 57.3 ± 1.7 | −80.1 ± 3.3 | −60.2 ± 0.3 | −140.3 ± 3.3 |

* The free surface energy component (mJ · m⁻²) with the electron donor parameter γ⁻, the electron acceptor parameter γ⁺, and the acid-base parameter γ^{AB} were measured. The standard deviations (±) were determined on the basis of at least 5 separate measurements.

These last parameters are relatively low for γ⁺ and high for γ⁻, which means that the ionene surfaces keep a strong basic character with the increase in the size of the hydrophobic segments. γ⁺ is higher for PI 3,3, which means that more positive charges are present, since they are exposed to the outside (water-surface contact) while the high increase in γ⁻ for PI 6,12 is probably due to a local increase in the concentration of counter-ions. The hydration energy calculations highlight a greater hydrophilia of PIs having longer hydrophobic segments, letting it be supposed that there is greater flexibility of the chains in this case.

### II.4. Impact of the Surfaces on the Adhesion of Undesirable Strains

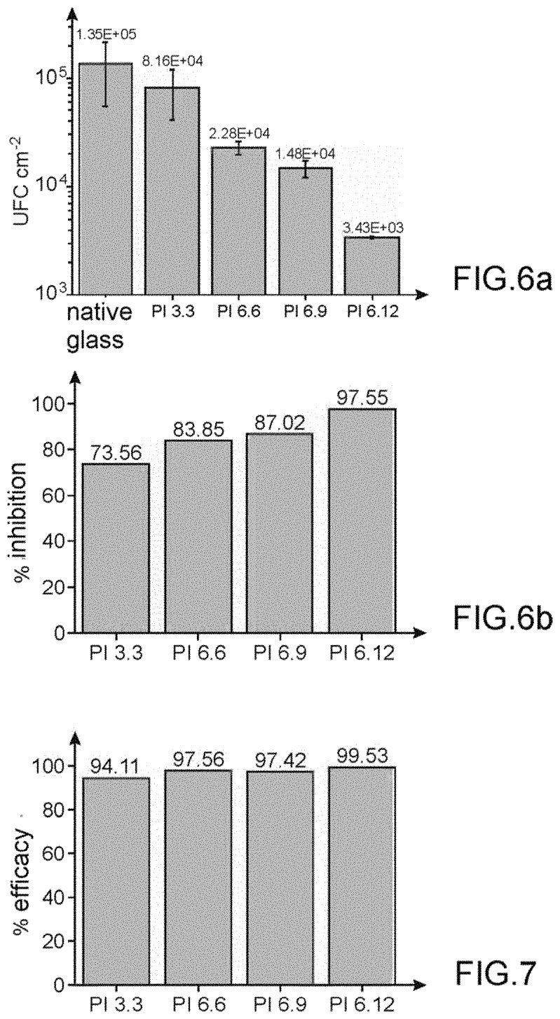

The results obtained from the microbiology tests on S. aureus and E. coli demonstrate the bacteriostatic properties of the surfaces grafted with ionenes. For S. aureus, the bacterial adhesion was evaluated in terms of counting adherent bacteria (total cells and viable cultivable cells) and of distribution/location of the bacteria (heterogeneity). FIG. 6a presents the results obtained from the tests of viable/cultivable cells. It is clear that the surfaces treated with polyionenes give rise to a reduction of more than 1 to 2 log UFC/cm² compared with the native surface, which corresponds to a reduction of 73.5 a 97.5% of the bacteria (see FIG. 6b).

In addition, the effective bacteriostatic effect of these treated surfaces is also attested to by the characterisation of the adhesion monitored by epifluorescence microscopy. It can be observed that the surface of the glass grafted with ionenes is completely covered with bacteria, while the initial surface (blank glass) shows a lower adhesion. These results show clearly that the ionene films lead to surfaces that are both pro-adhesive and biocidal, i.e. greatly bacteriostatic.

With respect to this highly pro-adhesive effect compared with the reference, it appeared important to review the determinations of the viables/cultivables also with respect to the total flora of each ionene surface, i.e. to standardise the inhibition percentages with respect to the number of bacteria initially adhered to the modified substrate. In FIG. 7, percentage efficacy is therefore preferentially spoken of in order to differentiate from the previous case (FIG. 6b).

It should be noted that the modified surfaces are then effective from 94 to 99.5% with respect to the bacteria actually trapped initially. The biocidal power with respect to the pro-adhesive properties of the surfaces are then clearly verified.

Comparable results were obtained using a PE film grafted with ionenes. Thus Table 6 below presents the count of the total flora of S. aureus by epifluorescence microscopy and viable/cultivable cells of S. aureus on a native PE surface, i.e. not treated, and on PE surfaces grafted with ionenes of type PI 3,3 or PI 6,6.

TABLE 6

| | | PE modified | PE modified |
|---|---|---|---|
| | Native | with PI | with PI |
| | PE | 3,3 | 6,6 |
| Total flora (bacteria/cm²) | 3.61E+03 | 2.27E+05 | 1.68E+05 |
| Viable cultivable (UFC/cm²) | 2.09E+02 | 3.93E+04 | 6.11E+03 |

From the results presented in Table 6, efficacy percentages with respect to S. aureus of 82.7% for PE surfaces grafted with ionenes of type PI 3,3 and of 96.4% for PE surfaces grafted with ionenes of type PI 6,6 are obtained.

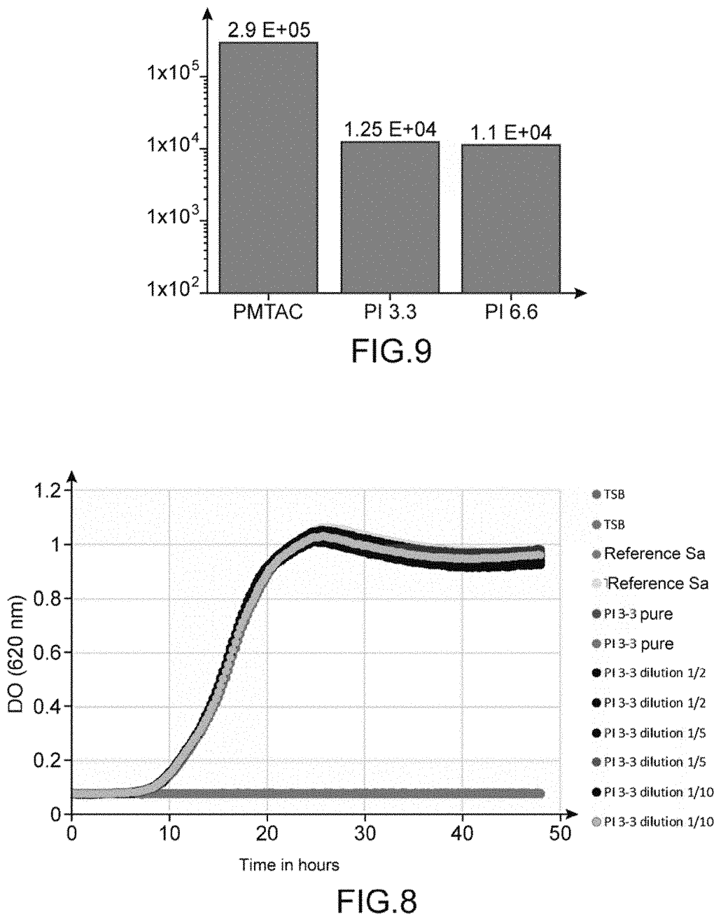

To check that the ionene polymer surfaces were grafted effectively and covalently onto the surfaces, the latter were placed in deionised water for 3 hours at 37° C., and the solution was next recovered to be used in bioscreen tests. MIC measurements were then made on S. aureus with various dilutions of the supernatant. These MIC measurements clearly showed that there is no inhibition of the bacteria growth (no bacteriostatic effect), which attests to the absence of polyionenes in the supernatant (which however have a very low MIC, as low as 1 μg/mL), and therefore the absence of release. An example is given for the substrates modified with PI 3,3 in FIG. 8, through the optical density measurements.

It can be seen in fact that the growth curves in FIG. 8 are all identical. No decrease is observed compared with the reference curves. This is consequently strong proof of robust and covalent grafting of the ionenes and of the efficacy of the washing procedures (deionised water/ethanol).

Additional comparisons were made with grafted PMTAC (poly(2-methacryloyloxyethyl)trimethylammonium chloride) containing quaternary ammoniums as pendant groups. As shown previously in the solution studies (see MIC measurements, previous paragraph), this polymer was also grafted in order to compare its bacteriostatic properties with those of the ionene films. Here the PMTAC was polymerised on the surface using the same method (polymerisation caused by diazonium salts) as the one used for preparing the sublayer of PDMA (see the experimental part).

In this case, strong adhesion was also observed on the substrate. However, the number of colonies of viable/cultivable cells (counting by UFC) is of the order of 2.9×10⁵, i.e. 1.8 log more than that determined for the ionene surfaces (PI 6,6) (FIG. 9). This means that the bacteriostatic effect of the ionenes is always much more effective than PMTAC after grafting on the surface (as observed previously in the solution tests). The PMTAC films are pro-adhesive, like the polyionene films, but do not inhibit or only very little inhibit the growth of strains.

In order to confirm the broad spectrum of action of the functionalised surfaces according to the invention, similar studies were carried out on a common Gram-negative strain: Escherichia coli. However, the tests performed in this case are different because the strain available was not modified fluorescent like S. aureus. Since direct counting was not possible in this case, a Live/Dead® marking kit was used. Indeed, in this case, the living and dead bacteria were directly marked on the basis of two fluorescent probes. From the images obtained, it is possible to clearly distinguish the living bacteria from the dead bacteria (which appear in red because of the propidium iodide, which cannot pass through the damaged membranes). As before with S. aureus, a strong adhesion of the bacteria was observed. Obviously a much greater bacteriostatic effect can be observed directly for the PI 6,6 surface compared with the PI 3,3 surface. From the photographs, the inventors were therefore able to estimate the viability percentage from the dead bacteria/total flora ratio. Thus an inhibition percentage of 78% was determined for the PI 3,3 surface and more than 98% for the PI 6,6 surface.

### II.5. Study of Release from PE Films Grafted with PI

The first microbiology tests on the PE films grafted with PIs showed that bacteria coming from the supernatant were also inhibited, which resulted in some of the PI on the surface not grafted being released in solution at the time of these tests.

A film washing protocol was therefore developed in order to improve the efficacy thereof and to solve the problem of the PIs just adsorbed on the surface. Indeed, as the PI is synthesised on the surface by polyaddition in the presence of two monomers, free monomer may be synthesised in solution and be adsorbed on the surface.

The washing protocol was therefore implemented in the following manner: washings with methanol of 30 minutes at 35-40° C. under stirring (MeOH) were performed, then followed by washing with deionised water of 30 minutes at 35-40° C. under stirring (H₂O), in order to remove any trace of methanol from the films before the microbiology tests. The sequence of washings tested is MeOH bath 1/MeOH bath 2/H₂O bath 1/H₂O bath 2/MeOH bath 3/MeOH bath 4/H₂O bath 3/H₂O bath 4.

To check the presence of PI in the washing solutions with methanol, the latter were evaporated then redispersed in the mixture of the mobile phase (methanol/water/acetic acid) of the steric exclusion chromatography (SEC). At the output from the column, it is possible to detect the presence of PI via two types of detection: refractometer (blue signal) and light diffusion (red signal). The refractometer is generally more sensitive, especially when it concerns, as here, polymers with low molar masses (below 10000 g/mol).

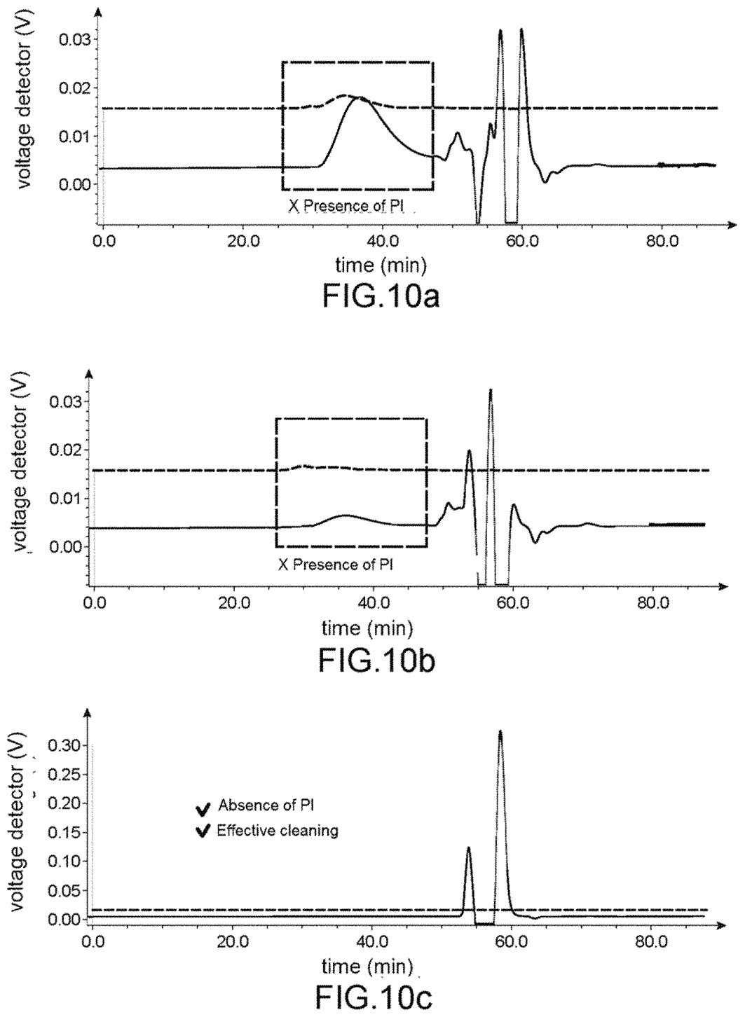

From the chromatograms of the 3 methanol baths (FIGS. 10a, 10b and 10c), it is clear that it is only in the last bath that the refractometer signal is truly flat, indicating the complete absence of polyionene.

From there, it was agreed that 3 washings with methanol followed by one washing with deionised water would be carried out after any grafting of PI on the PE films, prior to the microbiology and physicochemical tests.

### BIBLIOGRAPHY

[1] Dhende et al, ACS Appl. Mater. Interfaces 2011, 3, 2830.
[2] Li et al, RSC Adv. 2012, 2, 4031.
[3] Kurt et al, Langmuir 2007, 23, 4719.
[4] Mattheis et al, Macromol. Biosci. 2012, 12, 341.
[5] Lou et al, Acta Biomaterialia 2018, 78, 78-88.
[6] Strassburg et al, Macromol. Biosci. 2015, 15, 1710.
[7] Liu et al, Biomaterials 2017, 127, 36.
[8] Patent U.S. Pat. No. 4,980,067 published on 25 Dec. 1990.
[9] Liebscher et al, Langmuir 2013, 29, 10539-10548.
[10] Messersmith, Science 2010, 328, 180.
[11] Guardingo et al, Small 2014, 10, 1594-1602.
[12] Kohri and Kawamura, Polymer Science: Research Advances, Practical Applications and Educational Aspects (A. Ménndez-Vilas; A. Solano, Eds), 2016, 159.
[13] International application WO 2008/049108 published on 24 Apr. 2008.
[14] International application WO 2012/160120 published on 29 Nov. 2012.
[15] International application WO 2008/078052 published on 3 Jul. 2008.
[16] International application WO 2005/033378 published on 14 Apr. 2005.
[17] International application WO 2006/097611 published on 21 Sep. 2006.
[18] Ryu et al, ACS Appl. Mater. Interfaces 2018, 10, 7523-7540.
[19] Van Oss et al, Chem. Rev. 1988, 88, 927.
[20] Malikova et al, Physical Chemistry Chemical Physics 2012, 14, 12898.
[21] Engler et al, Biomacromolecules 2013, 14, 4331.
[22] Murata et al, Biomaterials 2007, 28, 4870.
[23] Lee et al, Biomacromolecules 2004, 5, 877.
[24] Dreyer et al, Langmuir 2012, 28, 6428.
[25] Neoh and Kang, ACS Appl. Mater. Interfaces 2011, 3, 2808.

1) A method for imparting bacteriostatic or bactericidal properties on the surface of an object consisting in:
a) providing an object, the surface of which bears groups comprising at least one oxygen atom;
b) depositing, on the surface provided in step (a), a coating based on polymers of polydopamine or one of the derivatives thereof, carrying at least one —Y function with Y representing a halogen atom or an —N(R11)(R12) function with R11 and R12, identical or different, representing a hydrogen atom, an alkyl group, optionally substituted, or an aryl group, optionally substituted; and
c) bringing the coated surface obtained following said step (b) in contact with a solution containing at least one dihalogen and at least one diamine at a temperature higher than ambient temperature, whereby a coating based on polyionene polymers is grafted, covalently, on said coated surface obtained following said step (b).

2) The method according to claim 1, wherein said group comprising at least one oxygen atom is selected from the group consisting of a carboxylic group (—C(═O)OH), a hydroxyl group (—OH), an alkoxyl group (—OX with X representing an alkyl group, an acyl group or an aryl group), a carbonyl group (—C(═O)—), a percarbonic group (—C(═O)—O—OH) and an amide group (—C(═O)NH₂).

3) The method according to claim 1, wherein said step (a) consists in subjecting the surface of the object to an oxidising treatment.

4) The method according to claim 1, wherein said polydopamine derivative is obtained by polymerising a dopamine derivative that complies with the following formula (II): 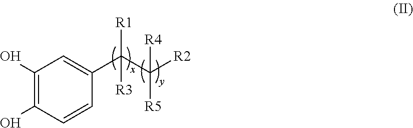
the R1, R2, R3, R4 and R5 groups are independently selected from the group consisting of a hydrogen, a hydroxyl, a halogen, a thiol, an aldehyde, a carboxylic acid, a carboxylic ester, a carboxamide, a primary amine, a secondary amine, a nitrile, an imidazole, an azide or a polyhexamethylene dithiocarbamate;
provided that at least one group from the R1, R2, R3, R4 and R5 groups is not a hydrogen;
x is equal to 0 or represents an integer number between 1 and 10, the bounds 1 and 10 being inclusive; and
y is equal to 0 or represents an integer number between 1 and 10, the bounds 1 and 10 being inclusive;
provided that x or y is at least equal to 1.

5) The method according to claim 1, wherein said step (b) comprises at least one operation, designated as oxidative autopolymerisation operation, consisting in bringing in contact, under oxidising conditions, the surface provided during step (a) with a solution containing a dopamine, one of the derivatives thereof or one of the salts thereof, whereby a coating based on polymers of polydopamine or of one of the derivatives thereof is deposited on said surface.

6) The method according to claim 5, wherein the oxidising conditions during said step (b) consist in using an alkaline solution containing a dopamine, one of the derivatives thereof or one of the salts thereof.

7) The method according to claim 5, wherein said oxidative autopolymerisation operation is followed by an operation during which a molecule carrying at least one or more —Y functions is grafted, covalently, onto the polymer of polydopamine or of polydopamine derivative by post-functionalisation.

8) The method according to claim 5, wherein said oxidative autopolymerisation operation is followed by an operation during which the coated surface obtained following the oxidative autopolymerisation operation is put in contact with a solution containing at least one aryl diazonium salt and optionally at least one radically polymerisable monomer different from an aryl diazonium salt and subjecting said solution to non-electrochemical conditions, provided that
when said solution does not contain a radically polymerisable monomer, said aryl diazonium salt has at least one —Y function,
when said solution contains at least one aryl diazonium salt and at least one radically polymerisable monomer, said aryl diazonium salt and/or said radically polymerisable monomer has at least one —Y function,
whereby radical entities are formed from said aryl diazonium salt and a coating based on polymers, identical or different, having at least one —Y function is grafted, covalently, onto said coated surface obtained following said oxidative autopolymerisation operation.

9) The method according to claim 8, wherein said non-electrochemical conditions are an organic reducing agent.

10) The method according to claim 1, wherein said diamine is of formula (VI):
(R13)(R14)N-A-N(R15)(R16) (VI)
wherein
R13, R14, R15 and R16, identical or different, represent a hydrogen atom, an alkyl group optionally substituted or an aryl group optionally substituted;
A is a chain chosen from the group consisting of an alkylene chain optionally substituted, an alkenylene or alkynylene chain optionally substituted, an arylene chain optionally substituted, an alkylarylene chain optionally substituted and an arylalkylene chain optionally substituted.

11) The method according to claim 10, wherein-said R13, R14, R15 and R16 radicals are identical and represent a methyl or an ethyl.

12) The method according to claim 1, wherein said dihalogen is of formula (VII):
(R17)-B—(R18) (VII)
wherein
R17 and R18, identical or different, represent a halogen; and
B is a chain selected from the group consisting of an alkylene chain optionally substituted, an alkenylene or alkynylene chain optionally substituted, an arylene chain optionally substituted, an alkylarylene chain optionally substituted and an arylalkylene chain optionally substituted.

13) The method according to claim 12, wherein the R17 and R18 radicals represent a bromine atom.

14) The method according to claim 1, wherein at least one washing step followed a rinsing step exists between step (a) and step (b), between the various operations during step (b) and/or between step (b) and step (c).

15) An object having a surface on which bacteriostatic or bactericidal properties have been imparted in accordance with a method as defined in claim 1.

16) An object according to claim 15, wherein said object is selected from the group consisting of a film such as for example a packaging film, a box, a tray, a case, a lid, a sachet, dialysis equipment, a rod, a probe, paper, a textile, a membrane and a filter.

17) Use of an object according to claim 15,
for packaging and/or preserving food products such as fresh food products, or
for purifying and/or decontaminating a solution, an object or a surface in the environmental or health field.
